(19) United States
(12) Patent Application Publication
(10) Pub. No.: US 2026/0238275 A1
(43) Pub. Date: Aug. 13, 2026

(54) DEVICES AND METHODS FOR COMMUNICATION

(71) Applicant: NEC CORPORATION, Tokyo (JP)

(72) Inventors: Peng GUAN, Beijing (CN); Yukai GAO, Beijing (CN); Gang WANG, Beijing (CN)

(73) Assignee: NEC CORPORATION, Tokyo (JP)

(21) Appl. No.: 19/153,854

(22) PCT Filed: Feb. 6, 2023
(86) PCT No.: PCT/CN2023/074668

§ 371 Date: Aug. 5, 2025

(51) Int. Cl. H04B 7/06; H04W 72/044

(52) U.S. Cl. CPC H04B 7/0626; H04B 7/0632; H04W 72/046

(57) ABSTRACT

Embodiments of the present disclosure provide a solution for network energy saving (NES). In a solution, a terminal device receives, from a network device, a first indication of a potential update to a property of a transmission in a first mode of the network device. The potential update causes the transmission to be performed in the first mode in a reduced manner as compared to a second mode of the network device, the transmission comprises at least one of a reference signal transmission or a physical channel transmission associated with a resource, the resource is used for at least one of a channel measurement or an interference measurement. The terminal device obtains information concerning the first mode based on a measurement on the resource in the second mode and the potential update applied at a first application timing. The terminal device transmits, to the network device, at least the information concerning the first mode.

### FIELDS

Example embodiments of the present disclosure generally relate to the field of communication techniques and in particular, to devices and methods for network energy saving (NES).

### BACKGROUND

Reducing the energy consumption of mobile networks, and particularly of the radio access network (RAN), which consumes the largest part of the total energy consumption in the network, has gained significant attention. Accordingly, network energy saving in the fifth generation (5G) communication system has been proposed. Studies on the network energy saving aim at identifying adaptation techniques of transmissions and/or receptions in time, frequency, spatial, and power domains. The techniques in spatial and power domains mainly aim to reduce the power consumption of the transceiver (TRX) chains and power amplifiers (PAs) by trying to shut down more spatial elements and/or reduce transmission power/power spectrum density or increase the PA efficiency. Adaptation of spatial elements and power offset values is needed in order to save network energy.

### SUMMARY

In general, embodiments of the present disclosure provide methods, devices and computer storage medium for network energy saving.

In a first aspect, there is provided a terminal device comprising: a processor configured to cause the terminal device to: receive, from a network device, a first indication of a potential update to a property of a transmission in a first mode of the network device, wherein the potential update causes the transmission to be performed in the first mode in a reduced manner as compared to a second mode of the network device, the transmission comprises at least one of a reference signal transmission or a physical channel transmission associated with a resource, the resource is used for at least one of a channel measurement or an interference measurement; obtain information concerning the first mode based on a measurement on the resource in the second mode and the potential update applied at a first application timing; and transmit, to the network device, at least the information concerning the first mode.

In a second aspect, there is provided a network device comprising: a processor configured to cause the network device to: transmit, to a terminal device, a first indication of a potential update to a property of a transmission in a first mode of the network device, wherein the potential update causes the transmission to be performed in the first mode in a reduced manner as compared to a second mode of the network device, the transmission comprises at least one of a reference signal transmission or a physical channel transmission associated with a resource, the resource is used for at least one of a channel measurement or an interference measurement; and receive, from the terminal device, information concerning the first mode, wherein the information is obtained based on a measurement on the resource in the second mode and the potential update applied at a first application timing.

In a third aspect, there is provided a terminal device comprising: a processor configured to cause the terminal device to: receive, from a network device, a second indication of a configuration associated with a resource, wherein the resource is used for at least one of a channel measurement or an interference measurement; determine whether a property of a transmission is updated during a time period, wherein the transmission comprises at least one of a reference signal transmission or a physical channel transmission associated with the resource, and the updated property causes the transmission to be performed in a first mode of the network device in a reduced manner as compared to a second mode of the network device; in accordance with a determination that the property is not updated, apply the configuration at a second application timing; and in accordance with a determination that the property is updated, apply the configuration at a third application timing, the third application timing be later than the second application timing.

In a fourth aspect, there is provided a network device comprising: a processor configured to cause the network device to: transmit, to a terminal device, a second indication of a configuration associated with a resource, wherein the resource is used for at least one of a channel measurement or an interference measurement; determine whether a property of a transmission is updated during a time period, wherein the transmission comprises at least one of a reference signal transmission or a physical channel transmission associated with the resource, and the updated property causes the transmission to be performed in a first mode of the network device in a reduced manner as compared to a second mode of the network device; in accordance with a determination that the property is not updated, apply the configuration at a second application timing; and in accordance with a determination that the property is updated, apply the configuration at a third application timing, the third application timing be later than the second application timing.

In a fifth aspect, there is provided a communication method performed by a terminal device. The method comprises: receiving, from a network device, a first indication of a potential update to a property of a transmission in a first mode of the network device, wherein the potential update causes the transmission to be performed in the first mode in a reduced manner as compared to a second mode of the network device, the transmission comprises at least one of a reference signal transmission or a physical channel transmission associated with a resource, the resource is used for at least one of a channel measurement or an interference measurement; obtaining information concerning the first mode based on a measurement on the resource in the second mode and the potential update applied at a first application timing; and transmitting, to the network device, at least the information concerning the first mode.

In a sixth aspect, there is provided a communication method performed by a network device. The method comprises: transmitting, to a terminal device, a first indication of a potential update to a property of a transmission in a first mode of the network device, wherein the potential update causes the transmission to be performed in the first mode in a reduced manner as compared to a second mode of the network device, the transmission comprises at least one of a reference signal transmission or a physical channel transmission associated with a resource, the resource is used for at least one of a channel measurement or an interference measurement; and receiving, from the terminal device, information concerning the first mode, wherein the information is obtained based on a measurement on the resource in the second mode and the potential update applied at a first application timing.

In a seventh aspect, there is provided a communication method performed by a terminal device. The method comprises: receiving, from a network device, a second indication of a configuration associated with a resource, wherein the resource is used for at least one of a channel measurement or an interference measurement; determining whether a property of a transmission is updated during a time period, wherein the transmission comprises at least one of a reference signal transmission or a physical channel transmission associated with the resource, and the updated property causes the transmission to be performed in a first mode of the network device in a reduced manner as compared to a second mode of the network device; in accordance with a determination that the property is not updated, applying the configuration at a second application timing; and in accordance with a determination that the property is updated, applying the configuration at a third application timing, the third application timing be later than the second application timing.

In an eighth aspect, there is provided a communication method performed by a network device. The method comprises: transmitting, to a terminal device, a second indication of a configuration associated with a resource, wherein the resource is used for at least one of a channel measurement or an interference measurement; determining whether a property of a transmission is updated during a time period, wherein the transmission comprises at least one of a reference signal transmission or a physical channel transmission associated with the resource, and the updated property causes the transmission to be performed in a first mode of the network device in a reduced manner as compared to a second mode of the network device; in accordance with a determination that the property is not updated, applying the configuration at a second application timing; and in accordance with a determination that the property is updated, applying the configuration at a third application timing, the third application timing be later than the second application timing.

In a ninth aspect, there is provided a computer readable medium having instructions stored thereon, the instructions, when executed on at least one processor, causing the at least one processor to carry out the method according to the fifth, sixth, seventh, or eighth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication environment in which example embodiments of the present disclosure can be implemented;

FIG. 2 illustrates a signaling flow of measurement and report for NES in accordance with some embodiments of the present disclosure;

FIG. 3 illustrates a schematic diagram of timing related to the first indication in accordance with some embodiments of the present disclosure;

FIG. 4 illustrates a schematic diagram of an accumulative mode for applying the potential update in accordance with some embodiments of the present disclosure;

FIG. 5 illustrates a schematic diagram of an example scenario for beam management and report in accordance with some embodiments of the present disclosure;

FIG. 6A illustrates a schematic diagram of an example scenario of CMR and IMR in accordance with some embodiments of the present disclosure;

FIG. 6B illustrates a schematic diagram of another example scenario of CMR and IMR in accordance with some embodiments of the present disclosure;

FIG. 7A illustrates a schematic diagram of an example scenario of beam failure detection in accordance with some embodiments of the present disclosure;

FIG. 7B illustrates a schematic diagram of an example scenario of candidate beam selection in accordance with some embodiments of the present disclosure;

FIG. 8 illustrates a signaling flow of application of associated configuration in accordance with some embodiments of the present disclosure;

FIG. 9 illustrates a schematic diagram of application of associated configuration in accordance with some embodiments of the present disclosure;

FIG. 10 illustrates a flowchart of a method implemented at a terminal device according to some example embodiments of the present disclosure

FIG. 11 illustrates a flowchart of a method implemented at a network device according to some example embodiments of the present disclosure;

FIG. 12 illustrates a flowchart of a method implemented at a terminal device according to some example embodiments of the present disclosure;

FIG. 13 illustrates a flowchart of a method implemented at a network device according to some example embodiments of the present disclosure; and

FIG. 14 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FR1 (e.g., 450 MHz to 6000 MHz), FR2 (e.g., 24.25 GHz to 52.6 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “cuplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, the terms “resource”, “beam” and “reference signal (RS)” may be used interchangeably.

The terms “power” and “energy” may include, but not limited to, transmitting (Tx) power, Energy per resource element (EPRE), Effective Isotropic Radiated Power (EIRP), receiving (Rx) power, reference signal received power (RSRP), Received Signal Strength Indicator (RSSI), etc. These terms may be used interchangeably.

The term “power backoff” may refer to an offset of a power as compared to a reference power. The power backoff may also be referred to as power offset, power reduction, etc. The term “power backoff” may also refer to an offset of a power in a first mode (e.g., the NES mode) as compared to a reference power in the second mode (e.g., a reference mode). In some embodiments, “power backoff for physical downlink shared channel (PDSCH)” or “PDSCH power backoff” as compared to the associated channel state information-reference signal (CSI-RS) may be used. As an example, PDSCH power backoff may be equal to PDSCH power in the second mode minus PDSCH power in the first mode. As another example, PDSCH power backoff may be equal to CSI-RS power in the second mode minus PDSCH power in the first mode. In a further example, PDSCH power backoff may be equal to (CSI-RS power in the second mode minus PDSCH power in the second mode) plus (PDSCH power in the second mode minus PDSCH power in the first mode). The absolute value for the power backoff for PDSCH may range from 0 dB (e.g., no backoff) to X dB (X be positive), e.g., 18 dB. Moreover, in the present disclosure, the PDSCH power may be equal to CSI-RS power minus the power backoff value. Alternatively, PDSCH power may be equal to CSI-RS power minus a power backoff value between CSI-RS and PDSCH minus a PDSCH power backoff between PDSCH power in the first and PDSCH power in the second mode.

It is noted that if the term “a ratio of PDSCH EPRE to CSI-RS EPRE” is used, then the PDSCH EPRE may be equal to the CSI-RS EPRE plus the ratio of PDSCH EPRE to CSI-RS EPRE. In particular, the ratio may be a negative value. If the term “a ratio of PDSCH EPRE in the first mode to CSI-RS EPRE in the second mode” is used, then the PDSCH EPRE in the second mode may be equal to the CSI-RS EPRE in the second mode plus the ratio. If the term “a first ratio of PDSCH EPRE in the second mode to CSI-RS EPRE in the second mode plus a second ratio of PDSCH EPRE in the first mode to PDSCH EPRE in the second mode” is used, then the PDSCH EPRE in the second mode may be equal to the CSI-RS EPRE in the second mode plus the first and second ratios.

In some embodiments, the PDSCH power backoff may not have an impact on UE assumption of PDSCH reception but have an impact on CSI computation. In some cases, a value for the PDSCH power backoff may be referred to as a “hypothetical value” and CSI computed based on the hypothetical value may be referred to as “hypothetical CSI”. Real PDSCH transmission may be performed with a power different from the CSI-RS power minus the power backoff value. However, it is to be noted that power backoff for PDSCH is an example, a power backoff for other signals or channels, including a power backoff of CSI-RS and synchronization signal physical broadcast channel (PBCH) block (SSB), is not excluded.

The term “spatial element” may include, but not limited to, an antenna port, a transceiver unit (TXRU), a radio frequency (RF) chain, transceiver chain, etc.

The term “beam indication” may include, but not limited to, a transmission configuration indicator (TCI), a TCI state, an uplink (UL) TCI state, a downlink (DL) TCI state, a unified TCI state, a spatial relation, spatial relation information, etc.

The term “beam measurement” may include, but not limited to, (L1-)RSRP measurement and/or signal to a (L1-)Signal to Interference plus Noise Ratio (SINR) measurement. The term “beam report” may include, but not limited to, (L1-)RSRP report and/or signal to a (L1-)SINR report.

The term “CSI” may include, but not limited to, a Channel Quality Indicator (CQI), a precoding matrix indicator (PMI), a CSI-RS resource indicator (CRI), an SS/PBCH Block Resource indicator (SSBRI), a layer indicator (LI), a rank indication (RI), an L1-RSRP, an L1-SINR or a Capability[Set] Index.

Principles and implementations of the present disclosure will be described in detail below with reference to the figures.

### Example Communication Environment

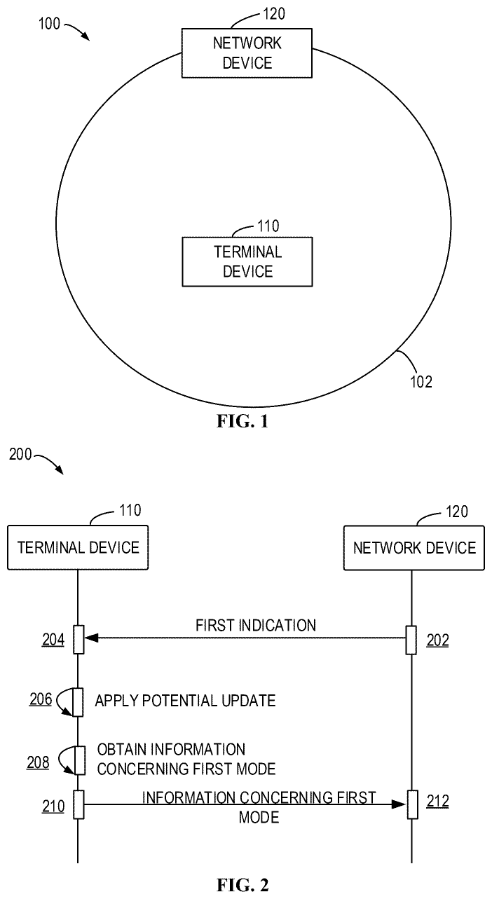

FIG. 1 illustrates a schematic diagram of an example communication environment 100 in which example embodiments of the present disclosure can be implemented. In the communication environment 100, a plurality of communication devices, including a terminal device 110 and a network device 120, can communicate with each other.

In the example of FIG. 1, the terminal device 110 may be a UE and the network device 120 may be a base station serving the UE. The serving area of the network device 120 may be called a cell 102. In the present disclosure, the terms “terminal device” and “UE” may be used interchangeably, and the terms “network device”, “base station” and “network (NW)” may be used interchangeably.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the cell 102, and one or more additional cells may be deployed in the communication environment 100.

In some example embodiments, a link from the network device 120 to the terminal device 110 is referred to as a DL, while a link from the terminal device 110 to the network device 120 is referred to as an UL. In DL, the network device 120 is a TX device (or a transmitter) and the terminal device 110 is a RX device (or a receiver). In UL, the terminal device 110 is a TX device (or a transmitter) and the network device 120 is a RX device (or a receiver).

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The network device 120 can sometimes operate in an NES mode, which is also referred to as a first mode. In the NES mode, some of hardware components of the network device 120 may be switched off or kept in a sleep state to obtain energy reduction. As a result, a transmission may be temporarily reduced as compared to a non-NES mode (which is also referred to as a second mode) until the NES mode is exited. The transmission may include, but not limited to, an RS transmission and a physical channel transmission. The RS transmission may include transmission of any suitable RS from the network device 120 to the terminal device 110, for example, CSI-RS, CSI-RS, demodulation reference signal (DMRS), broadcast signals (e.g., synchronization signal, secondary synchronization signal), etc. The physical channel transmission may include transmission of any suitable physical channel from the network device 120 to the terminal device 110, for example, PDSCH, physical downlink control channel (PDCCH), physical broadcast channel (PBCH), etc. In the following, some embodiments are described with respect to CSI-RS and PDSCH as examples. However, it is to be understood that the concept of the present disclosure can be applied to other reference signal and physical channel.

The NES mode may have different power states, for example, a deep sleep power state, a light sleep power state, a micro sleep power state, an active DL power state, and an active UL power state. In the deep sleep power state, there is neither DL transmission nor UL reception, and time interval for the sleep may be larger than the total transition time entering and leaving this state. In the light sleep power state, there is neither DL transmission nor UL reception, and time interval for the sleep may be larger than the total transition time entering and leaving this state. In the micro power state, there is neither DL transmission nor UL reception, and immediate transition is assumed for network energy saving study purpose from or to a non-sleep state. In the active DL power state, there is only DL transmission. In the There is only UL reception.

In order to support the NES mode, adaptation of spatial elements may be needed. Indication for potential enhancements related to adaptation of the spatial element may help the UEs to adapt the already configured CSI-RS configuration such as dynamic/semi-persistent ON-OFF of CSI-RS or to reconfigure the CSI-RS configuration, with respect to adapted number of spatial elements/ports. Dynamically adaptation of spatial elements such as the number of active transceiver chains or the number of active antenna panels at gNB in transmitting and/or receiving channels and signals needs to be enhanced. For example, the following aspects are needed to support NES: mechanisms to indicate spatial element adaptation to the UE; signaling to update the active CSI-RS configurations; enhancements on CSI-RS (re)configuration, CSI/Radio Resource Management (RRM)/Radio link monitoring (RLM) measurements, CSI reporting (e.g., multiple CSI reports), and beam management for gNB to switch between different spatial domain configurations; associated UE behavior in case of spatial element adaptation occurs, if needed, e.g., measurements, CSI feedback, power control, physical uplink shared channel (PUSCH)/PDSCH repetition, Sounding Reference Signal (SRS) transmission, TCI configuration, beam management, beam failure recovery, radio link monitoring, cell (re)selection, handover, initial access, etc.

In an aspect, adaptation of spatial elements of CSI-RS may be related to the number of CSI-RS ports, which may be configured by a radio resource control (RRC) parameter nrofPorts. Alternatively, the adaptation of spatial elements of CSI-RS may be implemented by confgurating multiple CSI-RS resources, or by bandwidth part (BWP) adaptation. In another aspect, TXRU may be categorized at a high level into fully digital, hybrid, and fully analogue beamforming systems. Usually, a hybrid architecture is assumed for massive MIMO, and/or for frequency range 2 (FR2). The change of TXRU number may result in the change of array gain, beamforming gain and/or TX power gain and eventually impacts the measured RSRP at UE side. If TXRU number is reduced to 1/K, EIRP/UE observed RSRP may be reduced by ceil(10*log 10(K)) dB. The change of TXRU number may or may not be the change of antenna port number.

Alternatively, or in addition, adaptation of transmission power of signals and channels may be needed. Solutions aim at adapting the transmission power or PSD of downlink signals and channels dynamically, by enhancing the related configuration to the UE (e.g., considering power offsets that account for potential power adaptation) and/or enhancing the UE feedback (e.g. CSI report) to assist NW energy saving operation. The technique may be applicable to one or more of PDSCH, CSI-RS, demodulation reference signal (DMRS), broadcast channels/signals (e.g., SSB, system information, SI, paging). Enhancements for updating the power offset values between various signals and channels, e.g., CSI-RS to SSB, or PDSCH to CSI-RS include using lower layer signalling. For example, the following aspects are needed to support NES: signalling of modified power of SSB or power ratio between CSI-RS and PDSCH/SSB to provide adaptation of power ratio values, e.g. by utilizing UE-specific, group-level or cell common signalling; enhancements on RRM measurements, beam management, beam failure recovery, radio link monitoring, cell (re)selection and handover procedure; enhancements to CSI measurements and reporting, e.g. multiple CSI reports in a single report.

In view of the above, solutions in spatial and power domains need to be specified. For example, enhancements on CSI and beam management related procedures including measurement and report, and signaling need to be specified to enable efficient adaptation of spatial elements (e.g., antenna ports, active transceiver chains). Enhancements on CSI related procedures including measurement and report, and signaling need to be specified to enable efficient adaptation of power offset values between PDSCH and CSI-RS.

In order to solve at least part of the above problems, embodiments of the present disclosure provide a solution for NES. According to some embodiments of the present disclosure, the network device transmits, to the terminal device, a first indication of a potential update to a property of a transmission in a first mode of the network device. The potential update would cause the transmission to be performed in the first mode in a reduced manner as compared to a second mode of the network device. The transmission comprises at least one of a reference signal transmission or a physical channel transmission associated with a resource, and the resource is used for at least one of a channel measurement (CM) or an interference measurement (IM). The terminal device applies the potential update applied at a first application timing and obtains information concerning the first mode based on a measurement on the resource in the second mode and the applied potential update. Then, the terminal device transmits at least the information concerning the first mode to the network device.

In these embodiments, the potential update is used to adjust a measurement result in the second mode, such that the information concerning the first mode is reported in advance. For example, CSI report or beam report can be performed for the first mode. In this way, measurement and report, and signaling in order to save network energy are enhanced and thus efficient adaptation (for example, efficient adaptation of spatial elements and of power offset values) is achieved.

### Example Signaling Flow for Measurement and Report

Potential update or change to a transmission associated with a resource for the purpose of NES (For example, a spatial element change or power change) may complicate the channel and interference environment. Take the CSI-RS and PDSCH transmission as an example. This may mean that the channel and interference environment when a measurement is performed on the CSI-RS resource is different from that when the PDSCH transmission associated with the CSI-RS resource is performed. As a result, some mismatch between reported CSI obtained by the CSI-RS resource and the channel condition during real PDSCH transmission may occur. Therefore, the CSI report or any other suitable report needs to take the potential update or change into account.

Reference is made to FIG. 2, which illustrates a signaling flow 200 of measurement and report for NES in accordance with some embodiments of the present disclosure. For the purposes of discussion, the signaling flow 200 will be discussed with reference to FIG. 1, for example, by using the terminal device 110 and the network device 120.

The network device 120 transmits 202, to the terminal device 110, a first indication of a potential update to a property of a transmission in a first mode of the network device 120. The potential update causes the transmission to be performed in the first mode in a reduced manner as compared to a second mode of the network device 120. For example, the first mode is the NES mode, and the second mode is the non-NES mode. The transmission, which may be also referred to as target transmission, comprises at least one of a RS transmission or a physical channel transmission associated with a resource (which may be also referred to as target resource), and the resource is used for at least one of a channel measurement or an interference measurement. In embodiments of the present disclosure, the target transmission can be associated with the target resource in any suitable manner. For example, the target transmission may be performed using the target resource, or a transmission using another resource associated with (for example, quasi-collocated (QCLed) with) the resource. In the following, the potential update may be also referred to as potential update associated with the resource or potential update to or of the resource for short without any limitation.

The resource may include, but not limited to, a CSI-RS resource, an SSB, an SRS resource, etc. As an example, the resource may be the CSI-RS resource and the transmission may be a CSI-RS transmission using the CSI-RS resource or a PDSCH transmission associated with the CSI-RS resource.

In some embodiments, the property may include an availability of the resource in the first mode, for example, an ON/OFF state of the resource in the first mode. Alternatively, or in addition, the property may include a first power configured by the network device 120 to perform the RS transmission in the second mode, for example, a CSI-RS power. Alternatively, or in addition, the property may include a second power configured by the network device 120 to perform the physical channel transmission in the first mode, for example, a PDSCH power. Alternatively, or in addition, the property may include a ratio of the first power to the second power, for example, a ratio of the CSI-RS power to the PDSCH power. Alternatively, or in addition, the property may include a spatial element configured by the network device 120 to perform the transmission in the first mode, for example, the number or ratio of antenna ports.

Take the CSI-RS resource and PDSCH transmission as an example. The first indication may be used to update values or parameters, such as a power backoff value for PDSCH, spatial elements of the CSI-RS resource. The power backoff value for PDSCH may or may not be directly related to an RRC configured ratio of PDSCH EPRE to CSI-RS EPRE. In an example, the power backoff value in the first indication may replace the RRC configured ratio when the first indication is applied, as described in detail below. In another example, the power backoff value in the first indication may be added on the RRC configured ratio when the first indication is applied.

The spatial elements of the CSI-RS resource may include antenna ports and/or TXRUs. The antenna ports of the CSI-RS resource may include the number of antenna ports, the port ID(s), the rank or port restriction for CSI report. Alternatively, or in addition, the spatial elements of the CSI-RS resource may include a difference between CSI-RS port(s) and PDSCH transmission port(s). TXRU of the CSI-RS resource may include a difference between the TXRU of CSI-RS transmission and the TXRU of PDSCH transmission. Update to the spatial elements may be indicated in a fractional number such as 1/X, alternatively, may be explicit N_CSI-RS to N_PDSCH, where N_CSI-RS represents a number of spatial elements for CSI-RS transmission, and N_PDSCH represents a number of spatial elements for PDSCH transmission. It is to be noted that 1/X of TXRU may be equivalent to reduction of power ratio of ceil(10*log 10(X)) dB.

The target resource can be indicated via any suitable field of the first indication, or a combination of two or more fields of the first indication. In some embodiments, the target resource may be indicated via an identification (ID) of a BWP comprising the target resource, which means that the first indication may be applied to resources in the BWP. Alternatively, or in addition, the target resource may be indicated via an ID of a component carrier (CC) comprising the target resource, which means that the first indication may be applied to resources in the CC. Alternatively, or in addition, the target resource may be indicated via an ID of the target resource. Alternatively, or in addition, the target resource may be indicated via an ID of a resource set comprising the target resource, which means that the first indication may be applied to resources in the resource set. Alternatively, or in addition, the target resource may be indicated via an ID of report configuration associated with the target resource, which means that the first indication may be applied to resources associated with the report configuration. Alternatively, or in addition, the target resource may be indicated via an ID of a TRP comprising the target resource, which means that the first indication may be applied to resources associated with the TRP.

For dynamic signaling, the first indication may be based on a media access control (MAC) control element (CE) and/or a downlink control information (DCI). Alternatively, in some embodiments, the first indication may be based on a combination of any two of RRC, MAC CE or DCI.

In an example, if an MAC CE is used to update power offset between the CSI-RS resource and PDSCH transmission, and/or the antenna ports of CSI-RS resources, the MAC CE may include a BWP/CC ID, a resource ID, or a resource set ID, or a report configuration ID. Alternatively, or in addition, the MAC CE may include TRP information, or control resource set (CORSET) pool index (CORESETPoolIndex). Alternatively, or in addition, the MAC CE may include power backoff value(s) of the PDSCH transmission. It is to be noted that if RRC configures multiple aperiodic triggers each corresponds to a power backoff value, only the trigger information is needed in the MAC CE. Alternatively, or in addition, the MAC CE may include the number of ports, or port index(es). It is to be noted that if RRC configures multiple aperiodic triggers each corresponds to a subset of ports, only the trigger information is needed in MAC CE.

In an example, if DCI is used, along with the fields for the potential update to the power backoff values and/or antenna ports, other fields such as BWP/CC ID, CSI request, may be included in the DCI. The indicated update to the power backoff value(s) and/or antenna ports is applied to the resources in the indicated BWP/CC, and the resources as indicated via the CSI request field Resource ID, or resource set ID, or report configuration ID. The bitwidth of the fields for the potential update to the power backoff values and/or antenna ports may depend on a range of values supported by the terminal device 110. Alternatively, or in addition, a specific DCI format and/or Radio Network Temporary Identifier (RNTI) may be used for power backoff value indication, and/or antenna ports update. Alternatively, or in addition, the DCI may be group common DCI with a group RNTI, which is intended for multiple terminal devices.

Continuing with the flow 200, the terminal device 110 receives 204 the first indication from the network device 120. The terminal device 110 applies 206 the potential update at a first application timing. In the present disclosure, application of the potential update and the application of the first indication can be used interchangeably.

For example, the application of the potential update may start from n+T+1 slot, where n is the time point (e.g., slot) for reception, decoding, or acknowledge (ACK) of the first indication. This means that the first application timing is n+T+1 slot. The value of T may be different based on the known/unknown status as will be described below. The value of T may be different for different parameters, for different signaling format used and for different UE capability.

Reference is now made to FIG. 3, which illustrates a schematic diagram of timing related to the first indication in accordance with some embodiments of the present disclosure. As shown, the CSI-RS configuration is provided to the terminal device 110 at the timing 301. The first indication is received at the timing 302 and an ACK for the first indication is transmitted at the timing n. A CSI-RS transmission is performed at the timing 303. The first indication or in other word the potential update is applied at the timing n+T+1, that is, the first application timing. Another CSI-RS transmission is performed at the timing 304. A CSI report is transmitted at the timing n′. For the CSI report at timing n′ (e.g., n′>n+τ, or n′>n+T+1+τ), the CSI report may be based on the CSI-RS transmission and corresponding measurement after the potential update is applied, where τ may be the required delay for CSI computation. Otherwise, the CSI report may be based on the CSI-RS transmission and corresponding measurement before the potential update is applied. In this way, alignment on when the updated value(s) can be applied for RS measurement/report or PDSCH transmission can be achieved.

Reference is now made back to FIG. 2. In some embodiments, to apply 206 the potential update, the terminal device 110 may determine at least one candidate value for the potential update and apply the potential update based on the at least one candidate value.

In some embodiments, a candidate value for the potential update may be determined in an absolute mode. In the absolute mode, the first indication may include an absolute value for the potential update and the absolute value may be used as the applied value.

Alternatively, or in addition, in some embodiments, a candidate value for the potential update may be determined in an accumulative mode. In the accumulative mode, the first indication may include an accumulative value for the potential update. The applied value is determined at least on based on a historically applied value and the accumulative value in the first indication. In some embodiments, the applied value may be determined further based on at least one further accumulative value in indications received before the first indication.

In some embodiments, the network device 120 may provide the terminal device 110 with an indication (which is also referred to as third indication) of whether the accumulative mode is enabled. In other word, the terminal device 110 may be provided with an indication for accumulative or absolute adjustment, e.g., an indication pc-Accumulation. In the case of accumulative mode, the adjustment is based on the historically applied value, for example, the latest applied value. In the case of absolute mode, the adjustment is based on the indicated value. The third indication may be provided via RRC, MAC CE or a field in DCI. For example, 1-bit in DCI may indicate whether the first indication is used for an absolute value or an accumulative value. In some embodiments, the MAC CE may be used to provide the absolute value, and DCI may be used to provide one or more accumulative values. It is to be noted that the accumulative mode is particularly suitable to indicate the update to the power backoff.

An example is now described with respect to the power backoff for PDSCH. In the example, DCI is used to carry the first indication, but this is an example without any limitation. If the accumulative mode is not enabled, for example, if the terminal device 110 is not provided with pc-Accumulation, the power backoff value for PDSCH on BWP b of carrier f of serving cell c and occasion i may be determined as:

$${f}_{b , f , c} ( i ) = {δ}_{b , f , c} ( i ) \qquad ( 1 )$$

where f_{b,f,c}(i) is the applied value, δ_{b,f,c}(i) is the value indicated via a field in DCI. The subscripts b, f, c may refer to the BWP/CC as the scheduling DCI or as indicated in the scheduled information, and these subscripts may or may not be needed. The occasion i stands for i-th CSI-RS transmission occasion of the CSI-RS resource. Alternatively, it may stand for i-th CSI measurement/report occasion. Alternatively, it may stand for i-th PDSCH transmission occasion. The variable i may or may not be needed, and may be intended to the CSI measurement/report triggered by the same DCI, or the CSI measurement/report after the application of the newly indicated values.

The exact value of adjustment may be not known at the time of RS measurement. To this end, in some embodiments, the first indication may provide multiple values for calculation under different hypothesis. In other words, there may exist multiple hypotheses with multiple values, that is, a plurality of candidate values for the potential update. In such embodiments, a variable k may be needed, e.g., as shown below:

$${f}_{b , f , c} ( i , k ) = {δ}_{b , f , c} ( i , k ) \qquad ( 2 )$$

where k stands for the value for k-th hypothesis.

If multiple DCI is received since the latest adjustment, the applied value may be only based on the latest indication. Examples of the δ_{b,f,c} values are given in Table 1. For the absolute value, the range and/or step size may be larger than that for accumulative value, the step size may be non-uniform (as in Table 1) or uniform. It is to be understood that 2-bit field in the Table 1 is used as an example, and the number of bits for indicating the accumulative value or absolute value may be any suitable number or depend on a configuration. Moreover, the accumulative values and absolute values as shown in FIG. 1 are also examples without any limitation.

TABLE 1
Example mapping between codepoint
value in DCI (2-bit field)
and the accumulative
value or absolute value

| Field | Accumulative | Absolute |
|---|---|---|
| in DCI | value [dB] | value [dB] |
| 0 | −3 | −3 |
| 1 | −1 | −6 |
| 2 | 0 | −9 |
| 3 | 1 | −18 |

If the accumulative mode is enabled, for example, if the terminal device 110 is provided with pc-Accumulation, the power backoff value for active BWP b of carrier f of serving cell c and PDSCH transmission occasion i may be determined as:

$${f}_{b , f , c} ( i ) = {f}_{b , f , c} ( i - {i}_{0} ) + {\sum }_{m = 0}^{C ( {D}_{i} ) - 1} {δ}_{b , f , c} ( m ) \qquad ( 3 )$$

where f_{b,f,c}(i) is the applied value for PDSCH transmission occasion i, δ_{b,f,c}(i) is the value indicated via a field in DCI. f_{b,f,c}(i−i₀) may be the applied value for PDSCH transmission occasion i−i₀. Alternatively, f_{b,f,c}(i−i₀) may be the last or latest applied value, or the configured value.

In some embodiments, there may exist multiple hypotheses with multiple values, that is, a plurality of candidate values for the potential update. In such embodiments, a variable k may be needed, e.g., as shown below:

$${f}_{b , f , c} ( i , k ) = {f}_{b , f , c} ( i - {i}_{0} , k ) + {\sum }_{m = 0}^{C ( {D}_{i} ) - 1} {δ}_{b , f , c} ( m ) \qquad ( 4 )$$

where k stands for the value for k-th hypothesis.

Examples of the δ_{b,f,c} values are given in Table 1. Alternatively, a different table may be provided for the accumulative value. In addition, the field indicating the accumulative value may have a different bitwidth from the bitwidth of the field indicating the absolute value.

In some embodiments, there may exist multiple hypotheses with multiple values and multiple DCI. In these embodiments, each DCI may include the same number of δ_{b,f,c}(k), as the number of hypotheses.

If multiple DCI is received since the latest adjustment, the accumulative value may be only based on the latest indication. Alternatively, the accumulative value may be based on the sum of indicated values in a time duration as shown in the equation (4), i.e.,

$${\sum }_{m = 0}^{C ( {D}_{i} ) - 1} {δ}_{b , f , c} ( m ) .$$

For example,

$${\sum }_{m = 0}^{C ( {D}_{i} ) - 1} {δ}_{b , f , c} ( m )$$

is a sum of power backoff values in a set Dᵢ of power backoff values with cardinality C(Dᵢ) that the terminal device 110 receives between K(i−i₀)−1 symbols before occasion i−i₀ and K(i) symbols before occasion i, where i₀>0 is the smallest integer for which K(i−i₀) symbols before occasion i−i₀ is earlier than K(i) symbols before occasion i. Alternatively, i₀ may be based on a configuration or a capability of the terminal device 110.

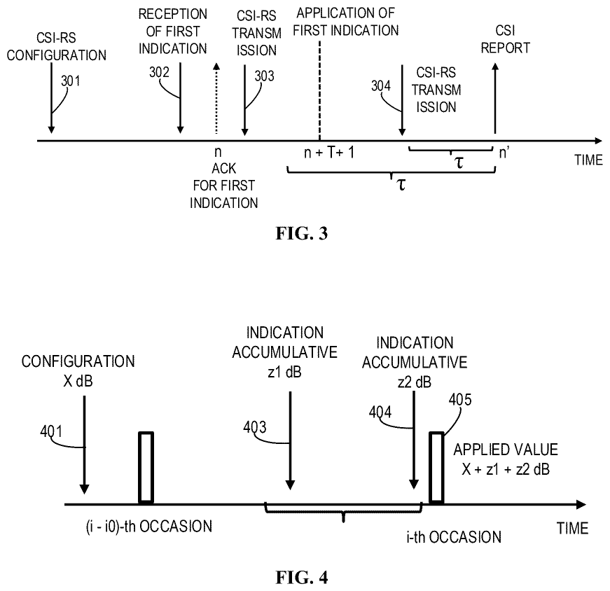

Reference is now made to FIG. 4, which illustrates a schematic diagram of an accumulative mode for applying the potential update in accordance with some embodiments of the present disclosure. At timing 401, a configuration indicating a power backoff value of X dB is received and the power backoff value of X dB is applied for the (i−i₀)th occasion. An indication with an accumulative value of z1 dB is received at the timing 403 and an indication with an accumulative value of z2 dB is received at the timing 404. Accordingly, the power backoff value of (X+z1+z2) dB is applied for the ith occasion.

Reference is now made back to FIG. 2. In some embodiments, the terminal device 110 may transmit capability information to the network device 120. For example, a capability reporting may be performed. The capability information may indicate at least one of: a value range for the property supported by the terminal device 110, a value or a stepsize of the value for the property supported by the terminal device 110, a value range for the potential update to the property supported by the terminal device 110, or a value or a stepsize of the value for the potential update to the property supported by the terminal device 110.

In an example, the capability reporting may define the range of values for the power backoff and/or antenna port/TXRU change. For example, the capability reporting may define the maximum power backoff value supported by the terminal device 110 for NES, e.g., 18 dB, 15 dB, . . . , 3 dB. Alternatively, or in addition, the capability reporting may define the maximum number of ports supported by the terminal device 110 for NES, including one or more of: CSI-RS ports, PDSCH ports, PDSCH layers, etc. Alternatively, or in addition, the capability reporting may define the maximum reduction of TXRU supported by the terminal device 110 for NES, e.g., ⅛, ¼, ½, etc. Alternatively, or in addition, the capability reporting may define the time duration for accumulation of power backoff value and/or antenna port/TXRU change supported by the terminal device 110.

In some embodiments, to reduce the signaling overhead, the potential update for the resource on one BWP/CC may be applied to a list of BWPs/CCs configured. Alternatively, or in addition, in some embodiments, to reduce the signaling overhead, the potential update for one resource in a resource set may be applied to the rest of resources in the resource set. In some embodiments with the multiple TRPs, the potential update may only be applied to the resources and/or PDSCH associated with the same TRP.

In some embodiments, one-time-indication may be assumed. Accordingly, the indicated potential update or change may only be applied to the next CSI-RS measurement/report and then the configured values. Alternatively, or in addition, in some embodiments, hold-till-next-indication may be assumed. Accordingly, the indicated potential update or change may be applied till the next indication.

Alternatively, in some embodiments, an expiry timer may be configured and the indicated potential update or change may only be applied till the timer expiries. Alternatively, in some embodiments, a prohibit timer can be configured, and the indicated potential update or change may be valid regardless of a next indication received when the timer is running.

In some embodiments, the update to the PDSCH power backoff and spatial element of the CSI-RS resource may not have an impact on the terminal device 110's assumption of PDSCH reception but may have an impact on CSI computation. Alternatively, in some embodiments, the update may also have an impact on PDSCH reception.

In some embodiments, in response to the first indication, the terminal device 110 may update other parameter or state to perform the target transmission. Specifically, the terminal device 110 may update one or more of the following: a max number of layers (or max layer) of a physical channel for the physical channel transmission, a number of codewords for the physical channel transmission, a usage of one or more parameters (for example, redundancy version (RV), new data indicator (NDI), modulation and Coding Scheme (MCS)) indicated in downlink control information scheduling the physical channel transmission for transmission block (TB) 2, or a number of symbols of a demodulation reference signal for the physical channel transmission.

Take the PDSCH transmission as an example. When the first indication is provided to the terminal device 110, the terminal device 110 is aware that PDSCH will be transmitted in a network energy saving mode, e.g., in a low specification or reduced manner. For example, the terminal device 110 may assume that PDSCH max layer is equal to the minimum one of maxMIMO-Layers and the updated number of CSI RS antenna ports, regardless of the configuration (or reported) of PDSCH max layer. Alternatively, or in addition, the terminal device 110 may assume that in DCI the fields of RV, NDI, MCS for TB 2 does not apply, regardless of the configuration of those fields. Alternatively, or in addition, the terminal device 110 may assume single codeword PDSCH, e.g., maxNrofCodeWordsScheduledByDCI=1, regardless of the configuration of two codewords PDSCH. Alternatively, or in addition, the terminal device 110 may assume that only one-symbol DMRS is used, maxLength=1, regardless of the configuration of 2-symbol DMRS.

Alternatively, or in addition, in some embodiments, in response to reception of the first indication, the terminal device 110 may be aware that a simpler CSI report may be needed to support the network energy saving mode, e.g., in a low overhead or resolution. For example, the terminal device 110 may assume type I codebook based CSI report, regardless of the configuration of type II CSI report. Alternatively, or in addition, the terminal device 110 may assume single user (SU) CSI report, regardless of the configuration of multi-user (MU) CSI report.

Continuing with FIG. 2, the terminal device 110 obtains 208 information concerning the first mode based on a measurement on the resource in the second mode and the applied potential update. Then, the terminal device 110 transmits 210 at least the information concerning the first mode to the network device 120. The network device 120 receives 212 at least the information concerning the first mode from the terminal device 110. In other words, even if the network device 120 does not enter into the first mode, by adjusting a measurement result in the second mode using the potential update, the terminal device 110 can report information (for example, CSI, beam management information) concerning the first mode. In this way, the mismatch between reported CSI obtained by the CSI-RS resource and real PDSCH transmission can be avoided.

### Channel Measurement and Interference Measurement

In some embodiments, the reported information may include CSI. To this end, the terminal device 110 may perform a CM and/or IM on the target resource. Then, the terminal device 110 may determine the CSI concerning the first mode based on the potential update and a result of the CM and/or IM, which is also referred to as a measurement result. Such CSI for the first mode is obtained based on the measurement in the second mode and thus may be referred to as hypothetic CSI or potential CSI.

In some embodiments, as mentioned above, a plurality of candidate values may be determined for the potential update. In these embodiments, the result of the CM and/or IM may be scaled using the plurality of candidate values to determine a plurality of results as the reported CSI.

The reported CSI may include any suitable items. In some embodiments, the terminal device 110 may determine a hypothetical RSRP in the first mode based on the measurement result and a potential transmission power of the transmission. Alternatively, or in addition, in some embodiments, the terminal device 110 may determine a hypothetical signal to noise ratio (SINR) in the first mode based on the measurement result and a potential transmission power of the transmission. Alternatively, or in addition, in some embodiments, the terminal device 110 may determine a hypothetical CQI in the first mode based on the result and a potential transmission power of the transmission. The hypothetical CQI may be further based on a hypothetical RI and a hypothetical PMI, as described below. The potential transmission power (for example, a potential power backoff value) may be determined based on the first indication, as described above.

Alternatively, or in addition, in some embodiments, the terminal device 110 may determine a hypothetical RI in the first mode based on the measurement result and a potential number of antenna ports for the transmission. Alternatively, or in addition, in some embodiments, the terminal device 110 may determine a hypothetical PMI in the first mode based on the measurement result and a potential number of antenna ports for the transmission. The hypothetical PMI may be further based on the hypothetical RI. The potential number of antenna ports may be determined based on the first indication, as described above.

Alternatively, or in addition, in some embodiments, the terminal device 110 may determine a CRI in the first mode based on the number of active resources associated with the resource, for example, the number of active resources in the resource set. Alternatively, or in addition, in some embodiments, the terminal device 110 may determine a SSBRI in the first mode based on the number of active resources associated with the resource.

In some embodiments, the reported information may further comprise a tolerance of the potential update to the property associated with a first portion of the resource for the channel measurement. For example, the terminal device 110 may report a tolerance of power backoff value for CM resource (CMR) with respect to a reference threshold. Alternatively, or in addition, the reported information may comprise a relaxation of the potential update to the property associated with a second portion of the resource for the interference measurement. For example, the terminal device 110 may report a relaxation of power backoff value for IM resource (IMR) with respect to a reference threshold.

The hypothetical CSI is described in general above. Now more embodiments and examples are described.

In some embodiments, beam measurement (BM) and report may be based on the potential update to the property of the transmission associated with the beam measurement resource, for example, the potential update to the ON/OFF status of the resource, the transmit power and/or spatial element for performing the transmission. By considering energy saving as a criterion, instead of the better RSRP/SINR measured, beams may be selected based on a potential performance assuming a lower power consumption.

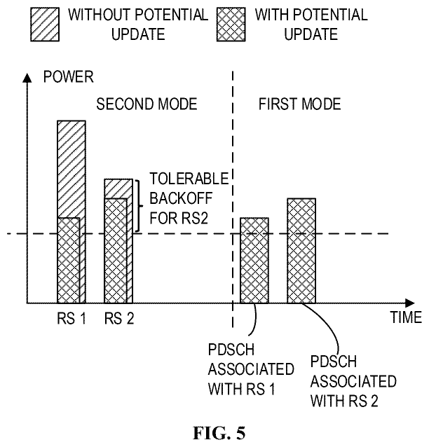

Now reference is made to FIG. 5, which illustrates a schematic diagram of an example scenario for beam management and report. The power for the vertical axis in FIG. 5 refers to a received power by the terminal device 110, for example, a RSRP. As shown, beam measurement in the second mode may be performed on the RS 1 and RS 2, where the RSRSP of RS 1 is higher than that of RS 2. After the network device 120 switches to the first mode, the PDSCH transmission associated with RS 1 would be received with a lower RSRP than the PDSCH transmission associated with RS 2. Therefore, by taking the potential update into account, RS 2 is selected for PDSCH transmission rather than RS 1.

To this end, in some embodiments, the beam selection criterion may be based on the potential update or the future state of the target resource, for example, the ON/OFF (or the number of active resources in a resource set), transmit power, the number of spatial elements, measured RSRP, etc. For example, the terminal device 110 shall not select those resources turned off or to be turned off. Selection of such a resource would cause a terminal device to lose reference (for example, a QCL reference) during the network device operates in the first mode. For another example, the terminal device 110 shall not select those resources to be transmitted with a lower power, a lower beamforming gain, a lower array gain, or a lower number of spatial elements, etc. Selection of such a resource would worsen received signal quality of the terminal device during the network device operates in the first mode. It is to be noted that the transmit power may not be the CSI-RS power, but the PDSCH power transmitted via the same beam.

In such embodiments, the first indication may be an indication that PDSCH is to be transmitted with a different power than CSI-RS. Alternatively, the first indication may have the details as described above.

In such embodiments, the first indication may provide potential power backoff value when transmitting PDSCH which is associated with the resource. The association between PDSCH and the resource may mean that PDSCH is QCLed with the RS which is transmitted using the resource. In other words, a same beam may be used to transmit the RS and the PDSCH.

In addition, the first indication may also provide potential spatial elements change. It is to be noted that it may not be common to change the antenna port number since BM RS usually is 1-port or 2-port CSI-RS. Change of TXRU number may be possible which may cause different beamforming gains applied for CSI-RS and PDSCH.

The reported CRI and/or SSBRI may be determined based on the number of active resources in the resource set comprising the target resource. Table 2 shows examples of the CRI and SSBRI.

TABLE 2
Examples of the CRI and SSBRI

| Field | Bitwidth |
|---|---|
| CRI | $⌈ {log}_{2} ( {K}_{s}^{CSI - RS} ) ⌉$ |
| SSBRI | $⌈ {log}_{2} ( {K}_{s}^{SSB} ) ⌉$ |

As an example,

$${K}_{s}^{CSI - RS}$$

is the number of active CSI-RS resources in the corresponding resource set, and

$${K}_{s}^{SSB}$$

is the configured number of active SS/PBCH blocks in the corresponding resource set.

Alternatively, or in addition, the reported RSRP may be a hypothetical RSRP, e.g., compensated or adjusted with the potential power backoff value. For example, the reported RSRP for RS1 may be equal to the RSRP measured on RS 1 minus the power backoff value configured for resource 1 corresponding to RS 1, and the reported RSRP for RS2 may be equal to the RSRP measured on RS 2 minus the power backoff value configured for resource 2 corresponding to RS 2.

If multiple power backoff values are indicated for one resource, multiple RSRPs compensated with each power backoff value respectively may be reported.

In addition, the terminal device 110 may report a tolerance of power backoff value with respect to a reference threshold, or the suggested tolerance/relaxation offset with respect to a configured/indicated backoff value. The tolerance or relaxation may be reported per CR1. For example, for RS 1, the terminal device 110 may report a RSRP measured on RS 1, and a tolerable backoff if PDSCH is QCLed with RS 1. For RS 2, the terminal device 110 may report a RSRP measured on RS 2, and a tolerable backoff if PDSCH is QCLed with RS 2. The tolerance may be a value or an indexed value of 3 dB, 6 dB, 9 dB, etc.

In some embodiments, the reported RI, PMI, and CQI may be based on the potential update to the property of the transmission associated with the CMR and IMR, for example, the potential update to the transmit power and/or spatial element associated with the resources. By considering the potential update, more accurate CQI, RI and PMI for real PDSCH transmission in network energy saving mode can be obtained.

In such embodiments, the first indication may provide a potential power backoff value when transmitting PDSCH which is associated with the resource. The PDSCH may be transmitted with a power backoff, which means that the CSI obtained by measuring CSI-RS might be mismatched. If PDSCH to CSI-RS power offset is dynamic, it may not be known when computing CQI. The terminal device 110 may report multiple CQIs per hypothesis.

Alternatively, or in addition, the first indication may provide a potential reduction value of spatial elements when transmitting PDSCH which is associated with the resource. Change of the antenna port number and/or TXRU number may have an impact on codebook selection for CSI report.

In such embodiments, the terminal device 110 may assume that the hypothetical PMI is conditioned on the hypothetical RI, and hypothetical CQI is conditioned on the hypothetical RI and the hypothetical PMI.

The reported RI may be a hypothetical RI, e.g., only considering P′ antenna ports of CSI-RS resources. P is the configured number of antenna ports, according to the legacy configuration signaling. P′ is the potential number of antenna ports, as indicated by the first indication. The first indication or other configuration signaling from the network device 120 to the terminal device 110 or the CSI report may also provide further information about the P′ antenna ports selected from the P antenna ports.

The reported PMI may be a hypothetical PMI, e.g., only considering P′ antenna ports of CSI-RS resources.

The reported CQI may be a hypothetical CQI, e.g., calculated or adjusted with the power backoff value. The reported hypothetical CQI may be in a format of differential value compared to the measured CQI. For example, 1st reported hypothetical differential CQI=1st reported hypothetical CQI−1st reported CQI.

The reported hypothetical CQI may be in a format of MCS/CQI adjustment indication, e.g., to indicate the network device 120 to transmit PDSCH with a higher MCS or a lower MCS, or to indicate the network device 120 to transmit PDSCH with a higher or lower power backoff value than configured. In addition, the terminal device 110 may report a tolerance of power backoff value with respect to a reference threshold, or the suggested tolerance/relaxation offset with respect to a configured/indicated backoff value. The tolerance or relaxation may be reported per CQI.

In some embodiments, if multiple power backoff values or spatial elements reduction values are indicated for one resource, the terminal device 110 may report multiple RIs adjusted with each value respectively, multiple PMIs adjusted with each value respectively, or multiple CQIs adjusted with each value respectively. The multiple CQIs may be reported in a differential manner, e.g., 2nd reported hypothetical differential CQI=2nd hypothetical CQI−1st reported hypothetical CQI.

As an example, if configured to report hypothetical CQI index, in the CSI reference resource, the terminal device 110 shall assume the following for the purpose of deriving the CQI index, and if also configured, for deriving hypothetical PMI and RI: the terminal device 110 shall assume that the corresponding PDSCH signals for vⱼ layers transmitted on the P′ antenna ports of the CSI-RS resource in Group j would have a ratio of EPRE to CSI-RS EPRE equal to the powerControlOffset of the respective CSI-RS resource, and potential power backoff value, if any, for j=1,2.

Attention is now paid to interference measurement. For CSI measurement(s) other than L1-SINR, the terminal device 110 may assume: each non-zero power (NZP) CSI-RS port configured for interference measurement corresponds to an interference transmission layer; all interference transmission layers on NZP CSI-RS ports for interference measurement take into account the associated EPRE ratios; other interference signal on resource elements (REs) of NZP CSI-RS resource for channel measurement, NZP CSI-RS resource for interference measurement, or CSI-IM resource for interference measurement. For L1-SINR measurement with dedicated interference measurement resources, the terminal device 110 may assume: the total received power on dedicated NZP CSI-RS resource for interference measurement or dedicated CSI-IM resource for interference measurement corresponds to interference and noise.

As briefly mentioned above, due to the switch of the network device from the second mode to the first mode, the interference environment when a measurement is performed on the CSI-RS resource is different from that when the PDSCH transmission associated with the CSI-RS resource is performed. In other words, the interference environment may be different between channel measurement phase and physical channel transmission phase.

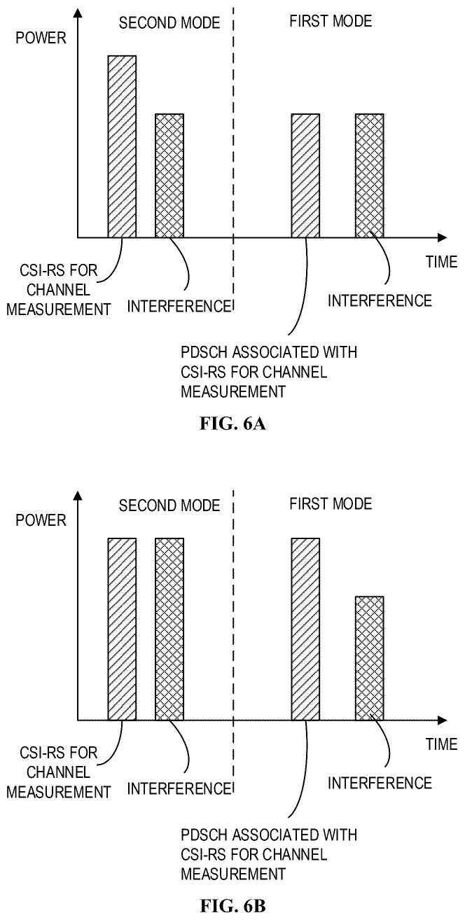

Reference is now made to FIG. 6A and FIG. 6B, which illustrates example scenarios of CMR and IMR. In the example of FIG. 6A, the transmission associated with the IMR keeps unchanged in the first mode as compared to the second mode, while PSDCH transmission associated with the CSI-RS is reduced in the first mode as compared to the CSI-RS transmission in the second mode. As a result, the interference would be underestimated and SINR would be overestimated.

In the example of FIG. 6B, the transmission associated with the IMR is reduced in the first mode as compared to the second mode, while PSDCH transmission associated with the CSI-RS keeps unchanged in the first mode. As a result, the interference would be overestimated and SINR would be underestimated.

To solve the above problem, in some embodiments, CSI measurement and report may be based on the potential update to the property of the transmissions associated with both the CMR and IMR, for example, the potential update to the ON/OFF status of the CMR and IMR, the transmit power and/or spatial element associated with both the CMR and IMR. By considering interference environment variation in addition to the signal quality in the NES mode, a more accurate SINR estimation can be achieved.

Take the potential update to the power as an example. Computation of SINR may be adapted. The SINR is based on a measurement via a CMR-IMR pair as an example without any limitation, where a CMR power refers to a power measured on the CMR and an IMR power refers to a power measured on the IMR. In the case without the switch form the second mode to the first mode, for example in the normal case, the SINR may be calculated by CMR power/IMR power.

If the signal power is expected to be changed in the first mode, the SINR may be calculated by (CMR power−power backoff)/IMR power. The intended (target) cell or beam is transmitting with a lower PDSCH power, which may cause lower SINR during the real transmission, for example as shown in FIG. 6A. In this case, SINR calculated by (CMR power/IMR power) during channel measurement phase would be overestimated.

If the interference power is expected to be changed in the first mode, the SINR may be calculated by CMR power/(IMR power−power backoff). Other cell or beam (which is interfering) is transmitting with lower PDSCH power, which may cause lower interference and higher SINR during the real transmission, for example as shown in FIG. 6B. In this case, SINR calculated by (CMR power/IMR power) during channel measurement phase would be underestimated.

If a mixed condition is met, that is, if both the signal power and interference power are expected to be changed in the first mode, the SINR may be calculated by (CMR power−power backoff)/(IMR power−power backoff).

It is to be noted that the CMR power backoff may be known at the network device 120. On the other hand, the IMR power backoff is not necessarily known at the network device 120, especially when the interfering source is another cell. Therefore, taking the potential update into account when calculating SINR can achieve a more accurate SINR estimation.

In some embodiments, given the ON/OFF of the CMR or IMR for one CMR-IMR pair, at least the following hypothesis may be made. For example, in the normal case, the CMR and IMR have a relation of 1-to-1 pairing. If the CMR is turned off, the associated beam should not be selected. If the IMR is turned off, the interference is measured on associated CMR resource only.

In some embodiments, for L1-SINR, the change of antenna port number may not be common case. For CSI other than L1-SINR, it is possible that CSI-RS port number is updated for CMR and/or IMR. The update of CMR port number is the same as described above with respect to beam measurement and report. The update of IMR port number may cause update of the interference transmission layer and the accumulate interference power.

The reported CRI and/or SSBRI may be determined by the number of active resources in the corresponding CMR resource set. The reported SINR may be a hypothetical SINR, e.g., compensated with the power backoff value. The reported SINR for CRI1 may be equal to the SINR measured on CMR1 and IMR1, and/or hypothetical SINR with a backoff configured for CMR1 and IMR1.

In addition, the terminal device 110 may report a tolerance of power backoff value with respect to a reference threshold. The tolerance may be reported per CRI. For example, for CRI 1, the terminal device 110 may report the SINR measured on CMR1 and IMR1, a tolerable power backoff if PDSCH is QCLed with CMR1.

If multiple power backoff values are indicated for one resource, the reported SINRs may be compensated with each backoff value respectively.

The reported CQI may be a hypothetical CQI, e.g., calculated with the backoff value for the CMR and IMR. The reported hypothetical CQI may be in a format of differential value compared to the measured CQI, e.g., 1st reported hypothetical differential CQI is equal to 1st reported hypothetical CQI minus 1st reported CQI.

The reported hypothetical CQI may be in a format of MCS/CQI adjustment indication, e.g., to indicate the network device 120 to transmit PDSCH with a higher or lower MCS, or to indicate the network device 120 to transmit PDSCH with a higher or lower power backoff value than configured.

In some embodiments, the terminal device 110 may report a tolerance of power backoff value for CMR with respect to a reference threshold. The tolerance may be reported per CQI.

In some embodiments, the terminal device 110 may report a relaxation of power backoff value for IMR with respect to a reference threshold. The relaxation may be reported per CQI.

In an example, for hypothetical CSI measurement(s) other than L1-SINR, the terminal device 110 assumes: each of P′ NZP CSI-RS port configured for interference measurement corresponds to an hypothetical interference transmission layer; all hypothetical interference transmission layers on NZP CSI-RS ports for interference measurement take into account the associated EPRE ratios configured, and the potential power backoff value, if any; other interference signal on REs ofNZP CSI-RS resource for channel measurement, NZP CSI-RS resource for interference measurement, or CSI-IM resource for interference measurement, with potential power backoff value, if any.

For hypothetical L1-SINR measurement with dedicated interference measurement resources, the terminal device 110 assumes: the total received power, with potential power backoff value, if any on dedicated NZP CSI-RS resource for interference measurement or dedicated CSI-IM resource for interference measurement corresponds to interference and noise.

### Beam Failure Recovery

In some embodiments, the reported information may include a beam failure report or a beam failure recovery request (BFRQ).

For a beam failure recovery procedure, the network device 120 transmits to the terminal device 110 a beam failure configuration, which may indicate the beam failure detection (BFD) RS. The network device 120 performs transmission of the BFD RS. The terminal device 110 monitors the BFD RS and performs BFD. If a beam failure is detected, the terminal device 110 selects a candidate beam from a plurality of candidate beams and transmits to the network device 120 the report or the BFRQ indicating the selected candidate beam. Then, the network device 120 transmits to the terminal device 110 a beam failure response and the PDSCH transmission is recovered using the selected candidate beam.

Traditionally, BFD is based on that UE assesses the radio link quality according to BFD RS (e.g., NZP CSI-RS) against threshold Q_{out,LR} (provided by the default of rlmInSyncOutOfSyncThreshold,) based on hypothetical PDCCH transmission parameters. The ratio of the PDCCH EPRE to NZP CSI-RS EPRE is assumed as 0 dB. The threshold Q_{out,LR} is defined as the level at which the downlink radio level link of a given resource configuration on set cannot be reliably received and shall correspond to the BLERout=10% block error rate (BLER) of a hypothetical PDCCH transmission.

However, in NES, PDSCH may be transmitted with a power backoff, and it implies that the channel condition for PDSCH may be worse than the channel condition for PDCCH.

To this end, in some embodiments, the BFD threshold may be enhanced or tightened based on hypothetical PDCCH monitoring. Specifically, the terminal device 110 may determine a first criterion for BFD in the first mode based on the potential update. The first criterion is tightened as compared to a second criterion for BFD in the second mode. The terminal device 110 may detect a beam failure based on the first criterion.

In general, the enhanced or tightened criterion for BFD is fulfilled when NES is enabled, and the PDCCH power is conditionally higher (for example, X dB) than the associated PDSCH power. The radio link quality on the configured BFD resource is evaluated to be better than the threshold Qᵢₙ+XdB.

In some embodiments, the potential ON/OFF state of the BFD RS may be considered. For example, the terminal device 110 shall not select those resources to be turned off/transmitted with a lower power as BFD RS. Alternatively, if the BFD-RS is to be turned off, some default RS (e.g., SSB) may be needed.

In some embodiments, the potential update to the transmit power of the BFD RS may be considered. In an example, the BFD threshold Q_{out,LR} (which is also referred to as the first threshold) may be scaled with a offset, e.g., BLERout<10%. In another example, the ratio of the hypothetical PDCCH EPRE to NZP CSI-RS EPRE may be assumed as X dB. The value of X is related to the PDSCH to CSI-RS power ratio, e.g., X may be equal to or smaller than PDSCH power backoff.

In a further example, in addition to against the threshold Q_{out,LR}, for PDSCH in the NES mode, another threshold (which is also referred to as the second threshold) may be introduce. The second threshold may be in the metric of RSRP, SINR, or BLER, e.g., a threshold Q_{out,PDSCH}, a threshold RSRP_{out,PDSCH}, or a threshold SINR_{out,PDSCH}. The terminal device 110 may assess the radio link quality to BFD RS (e.g., NZP CSI-RS) against the second threshold, by taking the potential transmit power in the first mode into consideration as well. For example, the terminal device 110 may apply the second threshold to the BLER, RSRP or SINR measurement obtained for a CSI-RS resource or a pair of CSI-RS resources after scaling a respective CSI-RS reception power with a value provided by the first indication respectively. In a further example, for beam failure detection, both the first and second thresholds need to be satisfied.

In some embodiments, 1-port RS may be used for BFD RS and thus the BFD RS may be not related to the antenna port update. In some embodiments, change of TXRU number may be possible which may cause different beamforming gains applied for CSI-RS and PDSCH.

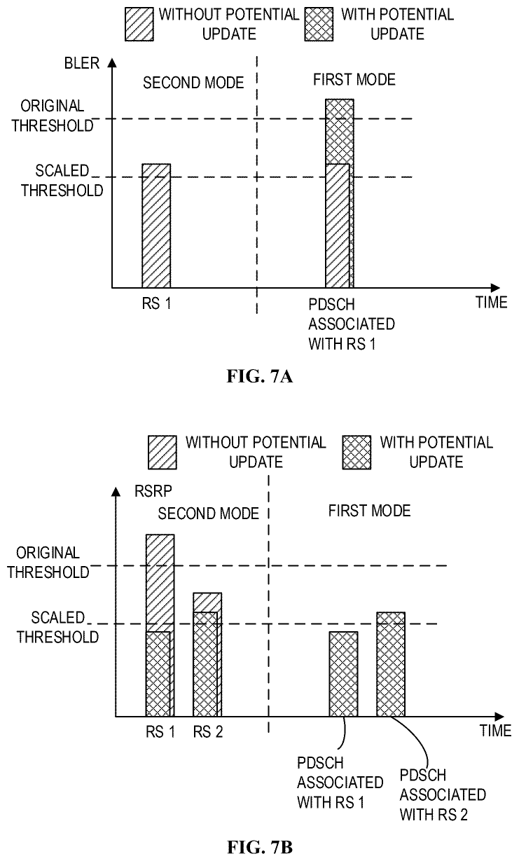

Reference is now made to FIG. 7A, which illustrates an example scenario of BFD. BLER is used as the threshold for BFD as example. In the example, RS 1 is measured in the second mode, and the corresponding BLER is below the original threshold in the second mode, for example, BLERout=10%. If PDSCH associated with RS 1 was transmitted in the first mode in a reduced manner, the resulting BLER would exceed the original threshold, which means that a beam failure should be detected for RS 1. By contrast, if the threshold is scaled, the corresponding BLER measured in the second mode exceeds the scaled threshold. As a result, the beam failure is detected for RS 1.

In such embodiments, the threshold for BFD is enhanced based on the potential update if PDSCH would be transmitted with a lower power in the NES mode. In this way, the case that PDCCH BLER is above threshold, but PDSCH transmission is with a worse channel condition can be avoided.

If the beam failure is detected, a candidate beam may be selected. Traditionally, the UE applies the Q_{in,LR} threshold to the L1-RSRP measurement obtained from a SS/PBCH block. The UE applies the Q_{in,LR} threshold to the L1-RSRP measurement obtained for a CSI-RS resource after scaling a respective CSI-RS reception power with a value provided by powerControlOffsetSS.

However, the selected candidate beam for PDSCH transmission in the NES mode will be transmitted with a power backoff compared to the transmit power of the RS associated with the selected candidate beam.

To this end, in some embodiments, the criterion for candidate beam selection may be relaxed based on RS RSRP measurement. Specifically, the terminal device 110 may determine a third criterion for candidate beam selection in the first mode based on the potential update. The third criterion is relaxed as compared to a fourth criterion for candidate beam selection in the second mode. The terminal device 110 may select the candidate beam from a plurality of candidate beams based on the third criterion.

In general, the relaxed criterion for candidate beam selection is fulfilled when the NES mode is enabled, and PDSCH power is conditionally lower (for example, X dB) than associated CSI-RS power. The radio link quality on the RS configured for the candidate beam (which is also referred to as candidate beam RS) is evaluated to be better than the threshold Qᵢₙ+XdB.

In some embodiments, the potential ON/OFF state of the RSs associated with the candidate beams may be considered. For example, dynamic update of the candidate beam RS may be considered.

In some embodiments, the potential transmit power of the candidate beam RS in the first mode may be considered. For example, the RSRP threshold for the candidate beam RS may be determined based on a hypothetical RSRP, since PDSCH may be transmitted with a lower power. In an example, the RSRP of the candidate beam RS may be compensated by the power backoff value and then compared to the configured legacy threshold. That is, the RSRP measured on RS minus the power back off value is compared to the configured legacy threshold.

In another example, the RSRP threshold of the candidate beam RS may be scaled by the power back off value. For example, the scaled threshold may be equal to the configured legacy threshold plus the power back off value. In a further example, both the legacy and scaled thresholds need to be satisfied.

In addition, in some embodiments, the terminal device 110 may report a tolerance of power backoff value for a beam used as the candidate beam for beam failure recovery with respect to a reference threshold, or a reported RSRP. Alternatively, the suggested tolerance or relaxation offset with respect to a configured or indicated backoff value may be reported. The tolerance, the suggested tolerance or relaxation offset may be reported along with information associated with the determined candidate RS index.

Reference is now made to FIG. 7B, which illustrate an example scenario for candidate beam selection. In the example, the candidate beam RS 1 measured with a higher RSRP in the second mode may correspond to a PDSCH transmission with a lower power in the first mode. On the other hand, the candidate beam RS 2 measured with a lower RSRP in the second mode (e.g., even lower than configured legacy RSRP threshold, as shown in FIG. 7B) may correspond to a PDSCH transmission with a higher power in the first mode (higher than PDSCH associated with RS1, i.e., transmitted with the same beam for RS1).

If the potential update was not considered, for example, the legacy RSRP threshold was used, the candidate beam associated with RS 2 would not be selected. By relaxing the criterion based on the potential update, the candidate beam associated with RS 2 is selected by the terminal device 110. In this way, more candidate beams can be selected for PDSCH transmission in the NES mode, eventually increasing the success rate of beam failure recovery.

### Example Signaling Flow for Associated Configuration

In some embodiments, the target resource may be associated with a configuration, which is also referred to as a target configuration. The target configuration may include but not limited to a TCI state, a spatial relation, a pathloss (PL) RS. For example, the target resource may be used as a reference for the TCI state, the spatial relation, or the PL RS. In this case, the update to the transmission associated with the target resource, for example, change of spatial elements or power of this resource, would have impacts on the associated TCI state, spatial relation, or PL RS.

The association between the target configuration and the target resource may be implemented in any suitable manner. In some embodiments, the target configuration may be associated with the resource, if the resource is directly indicated with or in the configuration. For example, the association between the TCI state, spatial relation, or PL-RS and the resource may include that the resource is directly indicated as a reference signal in the TCI state, spatial relation, or PL-RS configuration. Alternatively, or in addition, the target configuration may be associated with the resource, if the resource is indicated in an indirectly related configuration For example, the association between the TCI state, spatial relation, or PL-RS and the resource may include that the resource is indicated in an indirectly related TCI state, spatial relation, or PL-RS configuration (e.g., different TCI state, spatial relation, or PL-RS in different CC/BWP sharing the same TCI state, spatial relation, PL-RS ID respectively).

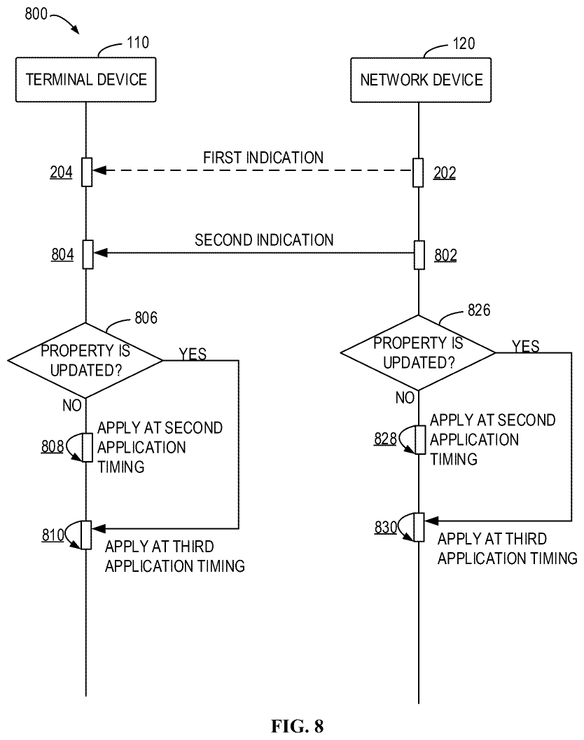

Reference is made to FIG. 8, which illustrates a signaling flow 800 of application of associated configuration in accordance with some embodiments of the present disclosure. For the purposes of discussion, the signaling flow 800 will be discussed with reference to FIG. 1, for example, by using the terminal device 110 and the network device 120.

The network device 120 transmits 802, to the terminal device 110, a second indication of the configuration associated with the target resource. The resource is used for at least one of a channel measurement or an interference measurement.

As mentioned above, the configuration may include at least one of the TCI state, the spatial relation, or the PL-RS. The second indication may be a signalling used to configure, activate, or indicate the at least one of the TCI state, the spatial relation, or the PL-RS.

The terminal device 110 receives 804 the second indication from the network device 120. The terminal device 110 determines 806 whether a property of a transmission is updated during a time period, which is also referred to as a target time period. The transmission comprises at least one of a reference signal transmission or a physical channel transmission associated with the resource, and the updated property causes the transmission to be performed in a first mode of the network device 120 in a reduced manner as compared to a second mode of the network device 120. In other words, the terminal device 110 determines whether the property of the transmission associated with the target resource is changed during the target time period. The target time period may be a time duration before the reception of the second indication.

If the property is not updated during the target time period, the terminal device 110 applies 808 the configuration at a second application timing. If the property is updated during the target time period, the terminal device 110 applies 810 the configuration at a third application timing. The third application timing is later than the second application timing.

In other words, if the property associated with the resource keeps unchanged during the target time period, the associated configuration may be considered as in a known state. Accordingly, the configuration can be used without too long delay. In contrast, if the property associated with the resource is changed during the target time period, the associated configuration may be considered as in an unknown state. Accordingly, the terminal device 110 shall wait for a longer time duration to apply the configuration.

In some embodiments, the application timing may be different for the TCI state, the spatial relation, or the PL-RS, as described below.

The target time period may have a fixed length, or it may have a dynamic length. In addition, the length of the target time period may be related to the periodicity of the resource. Alternatively, the length of the target time period may be reported by the terminal device 110 or configured by the network device 120.

In some embodiments, the length of the target time period may be different for the TCI state, the spatial relation, or the PL-RS. In some embodiments, the target time period may start from the reception or application of the first indication, the last transmission or report related to the resource. The target time period may last until the reception, acknowledgement, application of the second indication.

Continuing with the flow 800, to align the behaviors of the terminal device 110 and the network device 120, the network device 120 performs similar operations with the terminal device 110. Specifically, the network device 120 determines 826 whether the property of the transmission is updated during the target time period. In other words, the network device 120 determines whether the property of the transmission associated with the target resource is changed during the target time period.

If the property is not updated during the target time period, the network device 120 applies 828 the configuration at the second application timing. If the property is updated during the target time period, the network device 120 applies 830 the configuration at the third application timing.

In such embodiments, the known and unknown states may lead to different application timing of the indicated TCI state, spatial relation, or PL-RS. In this way, the terminal device 110 can obtain stable measurement results of the resource to determine its DL QCL assumption, UL Tx beam, UL Tx power.

The terminal device 110 may determine 806 whether the property is updated in any suitable manner. For example, if an activation indication of the potential update is received and applied, the terminal device 110 may determine that the property is updated and thus the configuration is in the unknown state.

In some embodiments, the first indication may be used to determine whether the property is updated. As shown in FIG. 8, the network device 120 may transmit 202 to the terminal device 110 the first indication of the potential update and the terminal device 110 may receive 204 the first indication from the network device 120. The terminal device 110 may apply the potential update at the first application timing. The first indication and the first application timing are similar as those described with reference to FIG. 2 and thus description thereof is not repeated here. If the first application timing is within the target time period, the terminal device 110 may determine that property is updated.

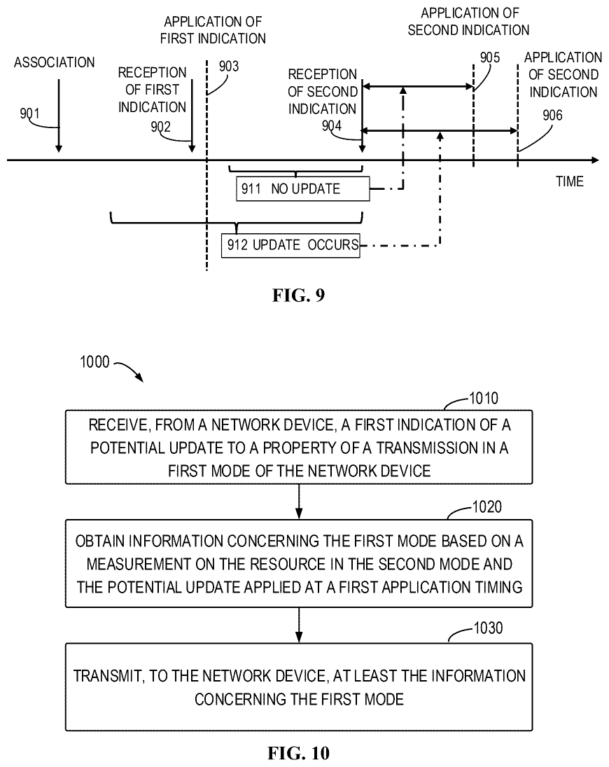

Reference is now made to FIG. 9, which illustrates an example of the application timing for the first and second indications. At timing 901, an association between the target configuration and the target resource is provided. For example, at least one of the TCI state, the spatial relation or the PL-RS is indicated to be associated with the resource. At timing 902, the first indication is received. For example, the first indication is used to update the transmit power or spatial element associated with the resource. The first indication is applied at the first application timing 903. At timing 904, the second indication is received.

In some embodiment, during the time period 911, the property is not updated. Accordingly, the target configuration is applied at the second application timing 905, which has a shorter time duration since the reception of the second indication. In some embodiments, during the time period 912, the property is updated. Accordingly, the target configuration is applied at the third application timing 906, which has a longer time duration since the reception of the second indication.

It is to be noted that in the flow 200, the application of the first indication may not means that the NES mode is entered, or may not mean a real change of the property. By contrast, in the flow 800, the application of the first indication may active the real change of the property.

In some embodiments, a TCI state associated with the resource is considered as “known” if the transmit power and/or spatial elements of the resource stay unchanged in a time period. In other words, the TCI state is considered as “unknown” if the transmit power and/or spatial elements of the resource have been changed in the time period. The “known” and “unknown” states may lead to different application timing. In this way, the terminal device 110 can obtain stable measurement results of the resource to determine its DL QCL assumption.

If the TCI state is known, the TCI state switch occurs at the first slot that is after

$$slot n + {T}_{HARQ} + 3 {N}_{slot}^{subframe , μ} + {TO}_{k} * ( {T}_{first - SSB} + {T}_{SSB - proc} ) / NR slot length .$$

The terminal device 110 shall be able to receive PDCCH with the old TCI state until

$$slot n + {T}_{HARQ} + 3 {N}_{slot}^{subframe , μ} .$$

T_{HARQ} is the timing between DL transmission and acknowledgement. T_{first-SSB} is time to first SSB transmission after MAC CE command is decoded by the terminal device 110, and the SSB shall be the QCL-TypeA or QCL-TypeC to target TCI state. T_{SSB-proc}=2 ms. TOₖ=1 if target TCI state is not in the active TCI state list for PDSCH, 0 otherwise.

If the target TCI state is unknown, upon receiving PDSCH carrying MAC-CE activation command in slot n, UE shall be able to receive PDCCH with target TCI state of the serving cell on which TCI state switch occurs at the first slot that is after

$$slot n + {T}_{HARQ} + 3 {N}_{slot}^{subframe , μ} + {T}_{L 1 - RSRP} + {TO}_{uk} * ( {T}_{first - SSB} + {T}_{SSB - proc} ) / NR slot length .$$

The UE shall be able to receive PDCCH with the old TCI state until

$$slot n + {T}_{HARQ} + 3 {N}_{slot}^{subframe , μ} ,$$

where
T_{L1-RSRP}=0 in FR1 or when the TCI state switching not involving QCL-TypeD in FR2. Otherwise,
T_{L1-RSRP} is the time for Rx beam refinement in FR2, defined as
T_{L1-RSPR_Measurement_Period_SSB} for SSB,
   with the assumption of M=1
   with T_{Report}=0
T_{L1-RSRP_Measurement_Period_CSI-RS} for CSI-RS
   configured with higher layer parameter repetition set to ON
   with the assumption of M=1 for periodic CSI-RS
   for aperiodic CSI-RS if number of resources in resource set at least equal to MaxNumberRxBeam
   with T_{Report}=0.

In some embodiments, the association between the TCI state and the resource may include: each TCI-State contains parameters for configuring a quasi co-location relationship between one or two downlink reference signals (i.e., the resource) and the DM-RS ports of the PDSCH, the DM-RS port of PDCCH or the CSI-RS port(s) of a CSI-RS resource. If applicable, TCI state configuration may provide a reference signal (i.e., the resource) for determining UL TX spatial filter for dynamic-grant and configured-grant based PUSCH and PUCCH resource in a CC, and SRS.

In an example, the TCI state is known if the following conditions are met:
During the period from the last transmission of the RS resource used for the L1-RSRP measurement reporting for the target TCI state to the completion of active TCI state switch, where the RS resource for L1-RSRP measurement is the RS in target TCI state or QCLed to the target TCI state
   TCI state switch command is received within 1280 ms upon the last transmission of the RS resource for beam reporting or measurement
   The UE has sent at least 1 L1-RSRP report for the target TCI state before the TCI state switch command
   The TCI state remains detectable during the TCI state switching period
   The transmit power of the RS associated with the TCI state remains unchanged during the period
   The spatial element of the RS associated with the TCI state remains unchanged during the period
   The SSB associated with the TCI state remain detectable during the TCI switching period
      SNR of the TCI state≥−3 dB
         Otherwise, the TCI state is unknown.

In another example, the downlink TCI state is known if the following conditions are met:
During the period from the last transmission of the RS resource used for the L1-RSRP measurement reporting for the target downlink TCI state to the completion of active downlink TCI state switch, where the RS resource for L1-RSRP measurement is the RS in target downlink TCI state or QCLed to the target downlink TCI state
   Downlink TCI state switch command is received within 1280 ms upon the last transmission of the RS resource for beam reporting or measurement
   The UE has sent at least 1 L1-RSRP report for the target downlink TCI state before the downlink TCI state switch command
   The target downlink TCI state remains detectable during the downlink TCI state switching period
   The transmit power of the RS associated with the downlink TCI state remains unchanged during the period
   The spatial element of the RS associated with the downlink TCI state remains unchanged during the period
   The SSB associated with the downlink TCI state remain detectable during the downlink TCI switching period
      SNR of the downlink TCI state≥−3 dB
      The SSB can be associated with either the serving cell PCI or a PCI different from serving cell PCI.

Otherwise, the downlink TCI state is unknown.

In another example, the uplink TCI state is known if the following conditions are met:
During the period from the last transmission of the RS resource used for the L1-RSRP measurement reporting for the target uplink TCI state to the completion of active uplink TCI state switch, where the RS resource for L1-RSRP measurement is the RS in target uplink TCI state or QCLed to the target uplink TCI state
   Uplink TCI state switch command is received within 1280 ms upon the last transmission of the RS resource for beam reporting or measurement
   The UE has sent at least 1 L1-RSRP report for the target uplink TCI state before the uplink TCI state switch command
   The RS configured in target uplink TCI state remains detectable during the uplink TCI state switching period
      SNR of the RS configured in target uplink TCI state≥−3 dB
   The target uplink TCI state remains detectable during the uplink TCI state switching period
   The transmit power of the RS associated with the uplink TCI state remains unchanged during the period
   The spatial element of the RS associated with the uplink TCI state remains unchanged during the period
   The SSB associated with the uplink TCI state remain detectable during the uplink TCI switching period
      SNR of the uplink TCI state≥−3 dB
      The SSB can be associated with either the serving cell PCI or a PCI different from serving cell PCI.
         Otherwise, the uplink TCI state is unknown.

In some embodiments, a spatial relation associated with a resource is considered as “known” if the transmit power and/or spatial elements of the resource stay unchanged in a time period. In other words, the spatial relation is considered as “unknown” if the transmit power and/or spatial elements of the resource have been changed in the time period. In this way, the terminal device 110 can obtain stable measurement results of the resource to determine its uplink transmit beam.

In some embodiments, if the target spatial relation associated to DL RS is known, upon receiving PDSCH carrying MAC-CE activation command in slot n, for UL spatial relation switch for PUCCH or semi-persistent SRS transmission of serving cell with a target UL spatial relation, the terminal device 110 shall be able to transmit PUCCH or semi-persistent SRS with the target UL spatial relation in the

$$slot n + {T}_{HARQ} + 3 {N}_{slot}^{subframe , μ} + 1$$

when beamCorrespondenceWithoutUL-BeamSweeping is set to 1 where T_{HARQ} is the timing between DL transmission and acknowledgement.

If the target spatial relation associated to DL RS is unknown, upon receiving PDSCH carrying MAC-CE activation command in slot n, for UL spatial relation switch for PUCCH or semi-persistent SRS transmission of serving cell with a target UL spatial relation, the terminal device 110 shall be able to transmit PUCCH or semi-persistent SRS with the target UL spatial relation in the

$$slot n + {T}_{HARQ} + 3 {N}_{slot}^{subframe , μ} + {T}_{L 1 - RSRP} + 1$$

when beamCorrespondenceWithoutUL-BeamSweeping is set to 1, where
T_{L1-RSRP} is the time for Rx beam refinement in FR2, defined as
   T_{L1-RSPR_Measurement_Period_SSB} for SSB,
   with the assumption of M=1
   with T_{Report}=0
   T_{L1-RSRP} Measurement Period CSI-RS for CSI-RS
   configured with higher layer parameter repetition set to ON
   with the assumption of M=1 for periodic CSI-RS
   for aperiodic CSI-RS if number of resources in resource set at least equal to MaxNumberRxBeam
with T_{Report}=0.

In some embodiments, the association between the spatial relation and the resource may include: the configuration of the spatial relation between a reference RS and the target SRS/PUSCH/PUCCH, where the higher layer parameter spatialRelationInfo or spatialRelationInfoPos, if configured, contains the ID of the reference RS (i.e., the resource).

In an example, the spatial relation associated to DL RS is known if the following conditions are met:
During the period from the last transmission of the DL RS resource used for the L1-RSRP measurement reporting for the target spatial relation to the completion of active spatial relation switch, where the DL RS resource for L1-RSRP measurement is the DL RS in target spatial relation or QCLed to the target spatial relation with QCL type-D.
   Spatial relation switch command is received within 1280 ms upon the last transmission of the DL RS resource for beam reporting or measurement
   The UE has sent at least 1 L1-RSRP report for the target spatial relation before the spatial relation switch command
   The DL RS configured in spatial relation remains detectable during the spatial relation switching period
      SNR of the DL RS configured in spatial relation≥−3 dB
   The transmit power of the RS associated with the spatial relation remains unchanged during the period
   The spatial element of the RS associated with the spatial relation remains unchanged during the period
   The SSB associated with the spatial relation remain detectable during the spatial relation switching period
      SNR of the SSB associated with the spatial relation≥−3 dB
         Otherwise, the spatial relation is unknown.

In some embodiments, a pathloss reference signal associated with a resource is considered as “known” if the transmit power and/or spatial elements of the resource stay unchanged in a time period. In other words, the pathloss reference signal is considered as “unknown” if the transmit power and/or spatial elements of the resource have been changed in the time period. In this way, the terminal device 110 can obtain stable measurement results of the resource to determine its UL transmit power.

If the target pathloss reference signal is known, upon receiving PDSCH carrying MAC-CE activation in slot n, the terminal device 110 shall be able to apply the target pathloss reference signal of the serving cell on which pathloss reference signal switch occurs no later than the

$$slot n + {T}_{HARQ} + 3 {N}_{slot}^{subframe , μ} + NM * ⌈ \frac{5 * {T}_{target \_ PL - RS} + 2 ms}{NR slot length} ⌉ .$$

The terminal device 110 shall be able to apply old pathloss reference signals until the

$$slot n + {T}_{HARQ} + 3 {N}_{slot}^{subframe , μ} ,$$

where
T_{HARQ} is the timing between pathloss reference MAC-CE activation command and acknowledgement;
NM=1, if the target PL-RS is not maintained by the UE, 0 otherwise;
T_{target_PL-RS} is the periodicity of the target pathloss reference signal which would be SSB or NZP CSI-RS.

Longer application time is expected if the pathloss reference signal is unknown.

In an example, the pathloss reference signal is known if the following conditions are met during the period between the last transmission of the RS resource used for L1-RSRP measurement reporting and the completion of pathloss reference signal switch, where the RS resource is the target pathloss reference signal or QCLed (with Type D) to the target pathloss reference signal.
Pathloss reference signal switch command is received within 1280 ms upon the last transmission of the RS resource for beam reporting or measurement
The UE has sent at least 1 L1-RSRP report for the target pathloss reference signal before the pathloss reference signal switch command
The target pathloss reference signal remains detectable during the pathloss reference signal switching period
   SNR of the target pathloss reference signal≥−3 dB
   The transmit power of the RS associated with the pathloss reference signal remains unchanged during the period
   The spatial element the RS associated with the pathloss reference signal remains unchanged during the period
   The associated SSBs with the target pathloss reference signal remain detectable during the pathloss reference signal switching period
      SNR of the associated SSB≥−3 dB
         Otherwise, the pathloss reference signal is unknown.

In addition, the pathloss may be determined based on a reference signal power and a higher layer filtered RSRP. For example, pathloss may be equal to referenceSignalPower minus a higher layer filtered RSRP, where referenceSignalPower is configured via RRC. If dynamic spatial elements or a power adaption is used for network energy saving, referenceSignalPower, beamforming gain, measured RSRP may be changed dynamically. To this end, in some embodiments, calculation of the pathloss may be changed.

In some embodiments, the termina device 110 may determine a pathloss from the network device 120 to the terminal device 110 based on a one-time difference between a reference signal power and a RSRP measured on the resource. In other words, L1-RSRP may be used for PL calculation. For example, L1 pathloss may be used for UL power determination, and the L1 pathloss may be equal to instantaneous reference signal power minus L1-RSRP.

Alternatively, or in addition, in some embodiments, the termina device 110 may determine the pathloss from the network device 120 to the terminal device 110 based on filtering of a plurality of differences between a reference signal power and a plurality of RSRPs measured on the resource. That is, the difference between Tx power and RSRP may be filtered. For example, instead of only filtering RSRP, the filtering is applied to the pathloss, such as the pathloss be equal to higher layer filtered (instantaneous reference signal power—L1-RSRP).

Alternatively, or in addition, in some embodiments, the termina device 110 may determine the pathloss from the network device to the terminal device based on a plurality of RSRPs measured on the resource after the property is updated. That is, only the RSRP after first application timing is filtered. For example, the terminal device 110 shall consider the pathloss reference signal as “not maintained” and pathloss estimation is calculated by a plurality of times (e.g., 5 times) measurements of the pathloss reference signal after applying transmit power/spatial element change of the reference signal.

### Example Methods and Devices

FIG. 10 illustrates a flowchart of a communication method 1000 implemented at a terminal device in accordance with some embodiments of the present disclosure. For the purpose of discussion, the method 1000 will be described from the perspective of the terminal device 110 in FIG. 1.

At block 1010, the terminal device 110 receives, from a network device 120, a first indication of a potential update to a property of a transmission in a first mode of the network device 120. The potential update causes the transmission to be performed in the first mode in a reduced manner as compared to a second mode of the network device 120. The transmission comprises at least one of a reference signal transmission or a physical channel transmission associated with a resource, and the resource is used for at least one of a channel measurement or an interference measurement.

At block 1020, the terminal device 110 obtains information concerning the first mode based on a measurement on the resource in the second mode and the potential update applied at a first application timing.

At block 1030, the terminal device 110 transmits, to the network device 120, at least the information concerning the first mode.

In some example embodiments, the property comprises at least one of: an availability of the resource in the first mode, a first power configured by the network device 120 to perform the reference signal transmission in the second mode, a second power configured by the network device 120 to perform the physical channel transmission in the first mode, a ratio of the first power to the second power, or a spatial element configured by the network device 120 to perform the transmission in the first mode.

In some example embodiments, the terminal device 110 may further determine at least one candidate value for the potential update at least based on the first indication; and apply the potential update based on the at least one candidate value.

In some example embodiments, the terminal device 110 may further determine an absolute value indicated in the first indication as a first candidate value of the at least one candidate value.

In some example embodiments, the terminal device 110 may further determine a second candidate value of the at least one candidate value at least based on a historical value for the property and an accumulative value indicated in the first indication.

In some example embodiments, the second candidate value may be determined further based on an accumulative value indicated in at least one further indication received during a time period before the reception of the first indication.

In some example embodiments, the terminal device 110 may further receive, from the network device 120, a third indication of whether an accumulative mode for determining the at least one candidate value is enabled.

In some example embodiments, the resource is indicated via at least one of: an identification of a bandwidth part comprising the resource, an identification of a component carrier comprising the resource, an identification of the resource, an identification of a resource set comprising the resource, an identification of a report configuration associated with the resource, or an identification of a transmission reception point associated with the resource.

In some example embodiments, the terminal device 110 may further transmit, to the network device 120, capability information indicating at least one of: a value range for the property supported by the terminal device 110, or a value range for the potential update to the property supported by the terminal device 110.

In some example embodiments, the transmission comprises the physical channel transmission, and the terminal device 110 may further in response to the first indication, update at least one of the following to perform the transmission with the network device 120: a max layer of a physical channel for the physical channel transmission, a number of codewords for the physical channel transmission, a usage of one or more parameters indicated in downlink control information scheduling the physical channel transmission for transmission block 2, or a number of symbols of a demodulation reference signal for the physical channel transmission.

In some example embodiments, the terminal device 110 may further perform a channel measurement and an interference measurement on the resource; and determine channel state information as at least part of the information concerning the first mode based on the potential update and a result of the channel measurement and the interference measurement.

In some example embodiments, a plurality of candidate values is determined for the potential update, and the terminal device 110 may further determine a plurality of results as the channel state information by scaling the result of the channel state measurement using the plurality of candidate values, respectively.

In some example embodiments, the terminal device 110 may further perform at least one of: determining a hypothetical reference signal received power (RSRP) in the first mode based the result and a potential transmission power of the transmission, determining a hypothetical signal to noise ratio (SINR) in the first mode based on the result and a potential transmission power of the transmission, determining a hypothetical rank indication (RI) in the first mode based on the result and a potential number of antenna ports for the transmission, determining a hypothetical precoding matrix indicator (PMI) in the first mode based on the result and a potential number of antenna ports for the transmission, or determining a hypothetical Channel Quality Indicator (CQI) in the first mode based on the result and a potential transmission power of the transmission.

In some example embodiments, the terminal device 110 may further perform at least one of: determining a channel state information reference signal resource indicator (CRI) in the first mode based on the number of active resources associated with the resource, or determining a synchronization signal-physical broadcast channel block resource indicator (SSBRI) in the first mode based on the number of active resources associated with the resource.

In some example embodiments, the information further comprises at least one of: a tolerance of the potential update to the property associated with a first portion of the resource for the channel measurement, or a relaxation of the potential update to the property associated with a second portion of the resource for the interference measurement.

In some example embodiments, the terminal device 110 may further determine a first criterion for beam failure detection in the first mode based on the potential update, wherein the first criterion is tightened as compared to a second criterion for beam failure detection in the second mode; and detect the beam failure based on the first criterion.

In some example embodiments, the information comprises an identification of a candidate beam for beam failure recovery, and the processor is further configured to cause the terminal device 110 to: determine a third criterion for candidate beam selection in the first mode based on the potential update, wherein the third criterion is relaxed as compared to a fourth criterion for candidate beam selection in the second mode; and select the candidate beam from a plurality of candidate beams based on the third criterion.

In some example embodiments, the terminal device 110 may further receive, from the network device 120, a second indication of a configuration associated with the resource; determine whether the property of the transmission is updated during a time period; in accordance with a determination that the property is not updated, apply the configuration at a second application timing; and in accordance with a determination that the property is updated, apply the configuration at a third application timing, the third application timing be later than the second application timing.

FIG. 11 illustrates a flowchart of a communication method 1100 implemented at a network device in accordance with some embodiments of the present disclosure. For the purpose of discussion, the method 1100 will be described from the perspective of the network device 120 in FIG. 1.

At block 1110, the network device 120 transmits, to a terminal device 110, a first indication of a potential update to a property of a transmission in a first mode of the network device 120. The potential update causes the transmission to be performed in the first mode in a reduced manner as compared to a second mode of the network device 120. The transmission comprises at least one of a reference signal transmission or a physical channel transmission associated with a resource, and the resource is used for at least one of a channel measurement or an interference measurement.

At block 1120, the network device 120 receives, from the terminal device 110, information concerning the first mode, wherein the information is obtained based on a measurement on the resource in the second mode and the potential update applied at a first application timing.

In some example embodiments, the property comprises at least one of: an availability of the resource in the first mode, a first power configured by the network device 120 to perform the reference signal transmission in the second mode, a second power configured by the network device 120 to perform the physical channel transmission in the first mode, a ratio of the first power to the second power, or a spatial element used by the network device 120 to perform the transmission in the first mode.

In some example embodiments, the network device 120 may further transmit, to the terminal device 110, a third indication of whether an accumulative mode for determining at least one candidate value for the potential update is enabled.

In some example embodiments, the resource is indicated via at least one of: an identification of a bandwidth part comprising the resource, an identification of a component carrier comprising the resource, an identification of the resource, an identification of a resource set comprising the resource, an identification of a report configuration associated with the resource, or an identification of a transmission reception point associated with the resource.

In some example embodiments, the network device 120 may further receive, from the terminal device 110, capability information indicating at least one of: a value range for the property supported by the terminal device 110, or a value range for the potential update to the property supported by the terminal device 110.

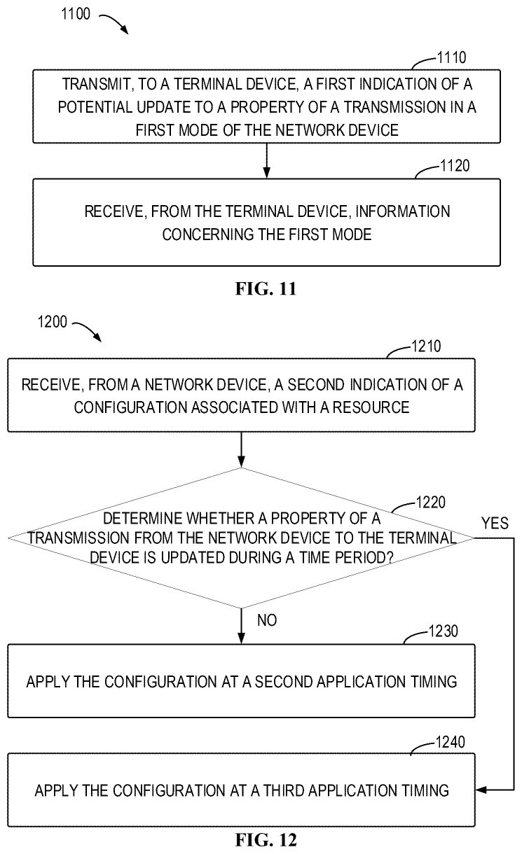

FIG. 12 illustrates a flowchart of a communication method 1200 implemented at a terminal device 110 in accordance with some embodiments of the present disclosure. For the purpose of discussion, the method 1200 will be described from the perspective of the terminal device 110 in FIG. 1.

At block 1210, the terminal device 110 receives, from a network device 120, a second indication of a configuration associated with a resource. The resource is used for at least one of a channel measurement or an interference measurement.

At block 1220, the terminal device 110 determines whether a property of a transmission is updated during a time period. The transmission comprises at least one of a reference signal transmission or a physical channel transmission associated with the resource, and the updated property causes the transmission to be performed in a first mode of the network device 120 in a reduced manner as compared to a second mode of the network device 120.

If the property is not updated, at block 1230, the terminal device 110 applies the configuration at a second application timing. If the property is updated, at block 1240, the terminal device 110 applies the configuration at a third application timing, the third application timing be later than the second application timing.

In some example embodiments, the configuration comprises at least one of: a Transmission Configuration Indicator state, a spatial relation, or a pathloss reference signal.

In some example embodiments, the configuration comprises the pathloss reference signal, and the terminal device 110 may further determine a pathloss from the network device 120 to the terminal device 110 based on at least one of: a one-time difference between a reference signal power and a reference signal received power measured on the resource, filtering of a plurality of differences between a reference signal power and a plurality of reference signal received powers measured on the resource, or a plurality of reference signal received powers measured on the resource after the property is updated.

In some example embodiments, the property comprises at least one of: an availability of the resource in the first mode, a first power configured by the network device 120 to perform the reference signal transmission in the second mode, a second power configured by the network device 120 to perform the physical channel transmission in the first mode, a ratio of the first power to the second power, or a spatial element used by the network device 120 to perform the transmission in the first mode.

In some example embodiments, the terminal device 110 may further receive, from the network device 120, a first indication of a potential update to the property; apply the potential update at a first application timing; and in accordance with a determination that the first application timing is within the time period, determine that the property is updated.

In some example embodiments, the terminal device 110 may further determine at least one candidate value for the potential update at least based on the first indication; and apply the potential update based on the at least one candidate value.

In some example embodiments, the terminal device 110 may further determine an absolute value indicated in the first indication as a first candidate value of the at least one candidate value.

In some example embodiments, the terminal device 110 may further determine a second candidate value of the at least one candidate value at least based on a historical value for the property and an accumulative value indicated in the first indication.

In some example embodiments, the second candidate value is determined further based on an accumulative value indicated in at least one further indication received during a time period before the reception of the first indication.

In some example embodiments, the terminal device 110 may further receive, from the network device 120, a third indication of whether an accumulative mode for determining the at least one candidate value is enabled.

In some example embodiments, the resource is indicated via at least one of: an identification of a bandwidth part comprising the resource, an identification of a component carrier comprising the resource, an identification of the resource, an identification of a resource set comprising the resource, an identification of a report configuration associated with the resource, or an identification of a transmission reception point associated with the resource.

In some example embodiments, the terminal device 110 may further transmit, to the network device 120, capability information indicating at least one of: a value range for the property supported by the terminal device 110, or a value range for the potential update to the property supported by the terminal device 110.

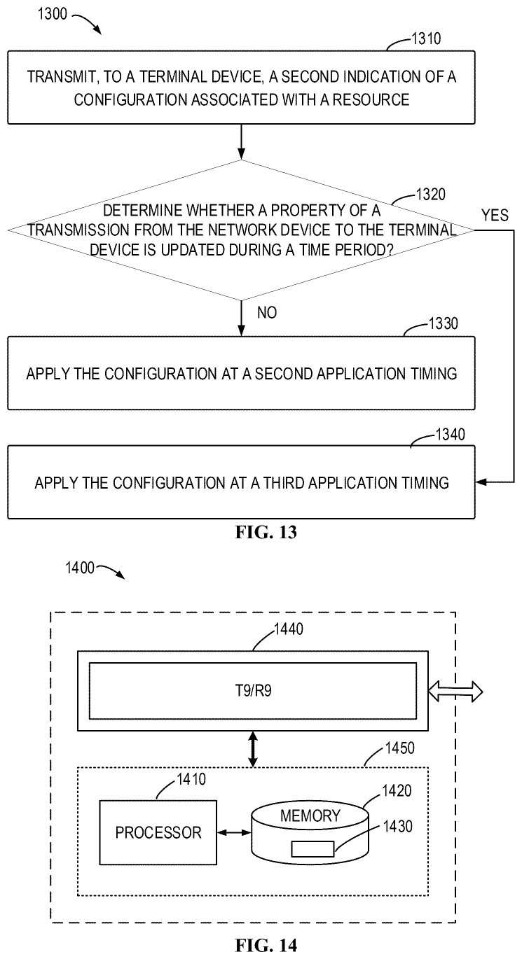

FIG. 13 illustrates a flowchart of a communication method 1300 implemented at a network device in accordance with some embodiments of the present disclosure. For the purpose of discussion, the method 1300 will be described from the perspective of the network device 120 in FIG. 1.

At block 1310, the network device 120 transmits, to a terminal device 110, a second indication of a configuration associated with a resource, wherein the resource is used for at least one of a channel measurement or an interference measurement.

At block 1320, the network device 120 determines whether a property of a transmission is updated during a time period. The transmission comprises at least one of a reference signal transmission or a physical channel transmission associated with the resource, and the updated property causes the transmission to be performed in a first mode of the network device 120 in a reduced manner as compared to a second mode of the network device 120.

If the property is not updated, at block 1330, the network device 120 applies the configuration at a second application timing. If the property is updated, at block 1340, the network device 120 applies the configuration at a third application timing, the third application timing be later than the second application timing.

In some example embodiments, the configuration comprises at least one of: a Transmission Configuration Indicator state, a spatial relation, or a pathloss reference signal.

In some example embodiments, the property comprises at least one of: an availability of the resource in the first mode, a first power configured by the network device 120 to perform the reference signal transmission in the second mode, a second power configured by the network device 120 to perform the physical channel transmission in the first mode, a ratio of the first power to the second power, or a spatial element used by the network device 120 to perform the transmission in the first mode.

In some example embodiments, the network device 120 may further transmit, to the terminal device 110, a first indication of a potential update to the property; and apply the potential update at a first application timing.

In some example embodiments, the network device 120 may further transmit, to the terminal device 110, a third indication of whether an accumulative mode for determining at least one candidate value for the potential update is enabled.

In some example embodiments, the resource is indicated via at least one of: an identification of a bandwidth part comprising the resource, an identification of a component carrier comprising the resource, an identification of the resource, an identification of a resource set comprising the resource, an identification of a report configuration associated with the resource, or an identification of a transmission reception point associated with the resource.

In some example embodiments, the network device 120 may further receive, from the terminal device 110, capability information indicating at least one of: a value range for the property supported by the terminal device 110, or a value range for the potential update to the property supported by the terminal device 110.

FIG. 14 is a simplified block diagram of a device 1400 that is suitable for implementing embodiments of the present disclosure. The device 1400 can be considered as a further example implementation of any of the devices as shown in FIG. 1. Accordingly, the device 1400 can be implemented at or as at least a part of the terminal device 110 or the network device 120.

As shown, the device 1400 includes a processor 1410, a memory 1420 coupled to the processor 1410, a suitable transmitter (TX)/receiver (RX) 1440 coupled to the processor 1410, and a communication interface coupled to the TX/RX 1440. The memory 1410 stores at least a part of a program 1430. The TX/RX 1440 is for bidirectional communications. The TX/RX 1440 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1430 is assumed to include program instructions that, when executed by the associated processor 1410, enable the device 1400 to operate in accordance with the embodiments of the present disclosure, as discussed herein with reference to FIGS. 2 to 13. The embodiments herein may be implemented by computer software executable by the processor 1410 of the device 1400, or by hardware, or by a combination of software and hardware. The processor 1410 may be configured to implement various embodiments of the present disclosure. Furthermore, a combination of the processor 1410 and memory 1420 may form processing means 1450 adapted to implement various embodiments of the present disclosure.

The memory 1420 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1420 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

According to embodiments of the present disclosure, a terminal device comprising a circuitry is provided. The circuitry is configured to: receive, from a network device, a first indication of a potential update to a property of a transmission in a first mode of the network device, wherein the potential update causes the transmission to be performed in the first mode in a reduced manner as compared to a second mode of the network device, the transmission comprises at least one of a reference signal transmission or a physical channel transmission associated with a resource, the resource is used for at least one of a channel measurement or an interference measurement; obtain information concerning the first mode based on a measurement on the resource in the second mode and the potential update applied at a first application timing; and transmit, to the network device, at least the information concerning the first mode. According to embodiments of the present disclosure, the circuitry may be configured to perform any method implemented by the terminal device as discussed above.

According to embodiments of the present disclosure, a network device comprising a circuitry is provided. The circuitry is configured to: transmit, to a terminal device, a first indication of a potential update to a property of a transmission in a first mode of the network device, wherein the potential update causes the transmission to be performed in the first mode in a reduced manner as compared to a second mode of the network device, the transmission comprises at least one of a reference signal transmission or a physical channel transmission associated with a resource, the resource is used for at least one of a channel measurement or an interference measurement; and receive, from the terminal device, information concerning the first mode, wherein the information is obtained based on a measurement on the resource in the second mode and the potential update applied at a first application timing. According to embodiments of the present disclosure, the circuitry may be configured to perform any method implemented by the network device as discussed above.

According to embodiments of the present disclosure, a terminal device comprising a circuitry is provided. The circuitry is configured to: receive, from a network device, a second indication of a configuration associated with a resource, wherein the resource is used for at least one of a channel measurement or an interference measurement; determine whether a property of a transmission is updated during a time period, wherein the transmission comprises at least one of a reference signal transmission or a physical channel transmission associated with the resource, and the updated property causes the transmission to be performed in a first mode of the network device in a reduced manner as compared to a second mode of the network device; in accordance with a determination that the property is not updated, apply the configuration at a second application timing; and in accordance with a determination that the property is updated, apply the configuration at a third application timing, the third application timing be later than the second application timing. According to embodiments of the present disclosure, the circuitry may be configured to perform any method implemented by the terminal device as discussed above.

According to embodiments of the present disclosure, a network device comprising a circuitry is provided. The circuitry is configured to: transmit, to a terminal device, a second indication of a configuration associated with a resource, wherein the resource is used for at least one of a channel measurement or an interference measurement; determine whether a property of a transmission is updated during a time period, wherein the transmission comprises at least one of a reference signal transmission or a physical channel transmission associated with the resource, and the updated property causes the transmission to be performed in a first mode of the network device in a reduced manner as compared to a second mode of the network device; in accordance with a determination that the property is not updated, apply the configuration at a second application timing; and in accordance with a determination that the property is updated, apply the configuration at a third application timing, the third application timing be later than the second application timing. According to embodiments of the present disclosure, the circuitry may be configured to perform any method implemented by the network device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In a first aspect, it is proposed a terminal device comprising: a processor configured to cause the terminal device to: receive, from a network device, a first indication of a potential update to a property of a transmission in a first mode of the network device, wherein the potential update causes the transmission to be performed in the first mode in a reduced manner as compared to a second mode of the network device, the transmission comprises at least one of a reference signal transmission or a physical channel transmission associated with a resource, the resource is used for at least one of a channel measurement or an interference measurement; obtain information concerning the first mode based on a measurement on the resource in the second mode and the potential update applied at a first application timing; and transmit, to the network device, at least the information concerning the first mode.

In some embodiments, the property comprises at least one of: an availability of the resource in the first mode, a first power configured by the network device to perform the reference signal transmission in the second mode, a second power configured by the network device to perform the physical channel transmission in the first mode, a ratio of the first power to the second power, or a spatial element configured by the network device to perform the transmission in the first mode.

In some embodiments, the processor is further configured to cause the terminal device to: determine at least one candidate value for the potential update at least based on the first indication; and apply the potential update based on the at least one candidate value.

In some embodiments, the processor is further configured to cause the terminal device to: determine an absolute value indicated in the first indication as a first candidate value of the at least one candidate value.

In some embodiments, the processor is further configured to cause the terminal device to: determine a second candidate value of the at least one candidate value at least based on a historical value for the property and an accumulative value indicated in the first indication.

In some embodiments, the second candidate value is determined further based on an accumulative value indicated in at least one further indication received during a time period before the reception of the first indication.

In some embodiments, the processor is further configured to cause the terminal device to: receive, from the network device, a third indication of whether an accumulative mode for determining the at least one candidate value is enabled.

In some embodiments, the resource is indicated via at least one of: an identification of a bandwidth part comprising the resource, an identification of a component carrier comprising the resource, an identification of the resource, an identification of a resource set comprising the resource, an identification of a report configuration associated with the resource, or an identification of a transmission reception point associated with the resource.

In some embodiments, the processor is further configured to cause the terminal device to: transmit, to the network device, capability information indicating at least one of: a value range for the property supported by the terminal device, or a value range for the potential update to the property supported by the terminal device.

In some embodiments, the transmission comprises the physical channel transmission, and the processor is further configured to cause the terminal device to: in response to the first indication, update at least one of the following to perform the transmission with the network device: a max layer of a physical channel for the physical channel transmission, a number of codewords for the physical channel transmission, a usage of one or more parameters indicated in downlink control information scheduling the physical channel transmission for transmission block 2, or a number of symbols of a demodulation reference signal for the physical channel transmission.

In some embodiments, the processor is further configured to cause the terminal device to: perform a channel measurement and an interference measurement on the resource; and determine channel state information as at least part of the information concerning the first mode based on the potential update and a result of the channel measurement and the interference measurement.

In some embodiments, a plurality of candidate values is determined for the potential update, and the processor is further configured to cause the terminal device to: determine a plurality of results as the channel state information by scaling the result of the channel state measurement using the plurality of candidate values, respectively.

In some embodiments, the processor is further configured to cause the terminal device to perform at least one of: determining a hypothetical reference signal received power (RSRP) in the first mode based the result and a potential transmission power of the transmission, determining a hypothetical signal to noise ratio (SINR) in the first mode based on the result and a potential transmission power of the transmission, determining a hypothetical rank indication (RI) in the first mode based on the result and a potential number of antenna ports for the transmission, determining a hypothetical precoding matrix indicator (PMI) in the first mode based on the result and a potential number of antenna ports for the transmission, or determining a hypothetical Channel Quality Indicator (CQI) in the first mode based on the result and a potential transmission power of the transmission.

In some embodiments, the processor is further configured to cause the terminal device to perform at least one of: determining a channel state information reference signal resource indicator (CRI) in the first mode based on the number of active resources associated with the resource, or determining a synchronization signal-physical broadcast channel block resource indicator (SSBRI) in the first mode based on the number of active resources associated with the resource.

In some embodiments, the information further comprises at least one of: a tolerance of the potential update to the property associated with a first portion of the resource for the channel measurement, or a relaxation of the potential update to the property associated with a second portion of the resource for the interference measurement.

In some embodiments, the processor is further configured to cause the terminal device to: determine a first criterion for beam failure detection in the first mode based on the potential update, wherein the first criterion is tightened as compared to a second criterion for beam failure detection in the second mode; and detect the beam failure based on the first criterion.

In some embodiments, the information comprises an identification of a candidate beam for beam failure recovery, and the processor is further configured to cause the terminal device to: determine a third criterion for candidate beam selection in the first mode based on the potential update, wherein the third criterion is relaxed as compared to a fourth criterion for candidate beam selection in the second mode; and select the candidate beam from a plurality of candidate beams based on the third criterion.

In some embodiments, the processor is further configured to cause the terminal device to: receive, from the network device, a second indication of a configuration associated with the resource; determine whether the property of the transmission is updated during a time period; in accordance with a determination that the property is not updated, apply the configuration at a second application timing; and in accordance with a determination that the property is updated, apply the configuration at a third application timing, the third application timing be later than the second application timing.

In a second aspect, it is proposed a network device comprising: a processor configured to cause the network device to: transmit, to a terminal device, a first indication of a potential update to a property of a transmission in a first mode of the network device, wherein the potential update causes the transmission to be performed in the first mode in a reduced manner as compared to a second mode of the network device, the transmission comprises at least one of a reference signal transmission or a physical channel transmission associated with a resource, the resource is used for at least one of a channel measurement or an interference measurement; and receive, from the terminal device, information concerning the first mode, wherein the information is obtained based on a measurement on the resource in the second mode and the potential update applied at a first application timing.

In some embodiments, the property comprises at least one of: an availability of the resource in the first mode, a first power configured by the network device to perform the reference signal transmission in the second mode, a second power configured by the network device to perform the physical channel transmission in the first mode, a ratio of the first power to the second power, or a spatial element used by the network device to perform the transmission in the first mode.

In some embodiments, the processor is further configured to cause the network device to: transmit, to the terminal device, a third indication of whether an accumulative mode for determining at least one candidate value for the potential update is enabled.

In some embodiments, the resource is indicated via at least one of: an identification of a bandwidth part comprising the resource, an identification of a component carrier comprising the resource, an identification of the resource, an identification of a resource set comprising the resource, an identification of a report configuration associated with the resource, or an identification of a transmission reception point associated with the resource.

In some embodiments, the processor is further configured to cause the network device to: receive, from the terminal device, capability information indicating at least one of: a value range for the property supported by the terminal device, or a value range for the potential update to the property supported by the terminal device.

In a third aspect, it is proposed a terminal device comprising: a processor configured to cause the terminal device to: receive, from a network device, a second indication of a configuration associated with a resource, wherein the resource is used for at least one of a channel measurement or an interference measurement; determine whether a property of a transmission is updated during a time period, wherein the transmission comprises at least one of a reference signal transmission or a physical channel transmission associated with the resource, and the updated property causes the transmission to be performed in a first mode of the network device in a reduced manner as compared to a second mode of the network device; in accordance with a determination that the property is not updated, apply the configuration at a second application timing; and in accordance with a determination that the property is updated, apply the configuration at a third application timing, the third application timing be later than the second application timing.

In some embodiments, the configuration comprises at least one of: a Transmission Configuration Indicator state, a spatial relation, or a pathloss reference signal.

In some embodiments, the configuration comprises the pathloss reference signal, and the processor is further configured to cause the terminal device to: determine a pathloss from the network device to the terminal device based on at least one of: a one-time difference between a reference signal power and a reference signal received power measured on the resource, filtering of a plurality of differences between a reference signal power and a plurality of reference signal received powers measured on the resource, or a plurality of reference signal received powers measured on the resource after the property is updated.

In some embodiments, the property comprises at least one of: an availability of the resource in the first mode, a first power configured by the network device to perform the reference signal transmission in the second mode, a second power configured by the network device to perform the physical channel transmission in the first mode, a ratio of the first power to the second power, or a spatial element used by the network device to perform the transmission in the first mode.

In some embodiments, the processor is further configured to cause the terminal device to: receive, from the network device, a first indication of a potential update to the property; apply the potential update at a first application timing; and in accordance with a determination that the first application timing is within the time period, determine that the property is updated.

In some embodiments, the processor is further configured to cause the terminal device to: determine at least one candidate value for the potential update at least based on the first indication; and apply the potential update based on the at least one candidate value.

In some embodiments, the processor is further configured to cause the terminal device to: determine an absolute value indicated in the first indication as a first candidate value of the at least one candidate value.

In some embodiments, the processor is further configured to cause the terminal device to: determine a second candidate value of the at least one candidate value at least based on a historical value for the property and an accumulative value indicated in the first indication.

In some embodiments, the second candidate value is determined further based on an accumulative value indicated in at least one further indication received during a time period before the reception of the first indication.

In some embodiments, the processor is further configured to cause the terminal device to: receive, from the network device, a third indication of whether an accumulative mode for determining the at least one candidate value is enabled.

In some embodiments, the resource is indicated via at least one of: an identification of a bandwidth part comprising the resource, an identification of a component carrier comprising the resource, an identification of the resource, an identification of a resource set comprising the resource, an identification of a report configuration associated with the resource, or an identification of a transmission reception point associated with the resource.

In some embodiments, the processor is further configured to cause the terminal device to: transmit, to the network device, capability information indicating at least one of: a value range for the property supported by the terminal device, or a value range for the potential update to the property supported by the terminal device.

In a fourth aspect, it is proposed a network device comprising: a processor configured to cause the network device to: transmit, to a terminal device, a second indication of a configuration associated with a resource, wherein the resource is used for at least one of a channel measurement or an interference measurement; determine whether a property of a transmission is updated during a time period, wherein the transmission comprises at least one of a reference signal transmission or a physical channel transmission associated with the resource, and the updated property causes the transmission to be performed in a first mode of the network device in a reduced manner as compared to a second mode of the network device; in accordance with a determination that the property is not updated, apply the configuration at a second application timing; and in accordance with a determination that the property is updated, apply the configuration at a third application timing, the third application timing be later than the second application timing.

In some embodiments, the configuration comprises at least one of: a Transmission Configuration Indicator state, a spatial relation, or a pathloss reference signal.

In some embodiments, the property comprises at least one of: an availability of the resource in the first mode, a first power configured by the network device to perform the reference signal transmission in the second mode, a second power configured by the network device to perform the physical channel transmission in the first mode, a ratio of the first power to the second power, or a spatial element used by the network device to perform the transmission in the first mode.

In some embodiments, the processor is further configured to cause the network device to: transmit, to the terminal device, a first indication of a potential update to the property; and apply the potential update at a first application timing.

In some embodiments, the processor is further configured to cause the network device to: transmit, to the terminal device, a third indication of whether an accumulative mode for determining at least one candidate value for the potential update is enabled.

In some embodiments, the resource is indicated via at least one of: an identification of a bandwidth part comprising the resource, an identification of a component carrier comprising the resource, an identification of the resource, an identification of a resource set comprising the resource, an identification of a report configuration associated with the resource, or an identification of a transmission reception point associated with the resource.

In some embodiments, the processor is further configured to cause the network device to: receive, from the terminal device, capability information indicating at least one of: a value range for the property supported by the terminal device, or a value range for the potential update to the property supported by the terminal device.

In an aspect, a computer readable medium having instructions stored thereon, the instructions, when executed on at least one processor, causing the at least one processor to perform the method implemented by the terminal device discussed above.

In an aspect, a computer readable medium having instructions stored thereon, the instructions, when executed on at least one processor, causing the at least one processor to perform the method implemented by the network device discussed above.

In an aspect, a computer program comprising instructions, the instructions, when executed on at least one processor, causing the at least one processor to perform the method implemented by the terminal device discussed above.

In an aspect, a computer program comprising instructions, the instructions, when executed on at least one processor, causing the at least one processor to perform the method implemented by the network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 14. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method of a User Equipment (UE) comprising:
receiving configuration information comprising a power offset between a Physical Downlink Shared Channel (PDSCH) and a Channel State Information Reference Signal (CSI-RS),
calculating information for Channel State Information (CSI) based on the configuration information, and
transmitting the CSI,
wherein the power offset is information for energy saving of a network through adapting power domain.

22. The method of claim 21, wherein:
the calculation comprises a calculation of Channel Quality Indicator (CQI) based on the power offset, and
wherein the CQI is related to Rank Indicator (RI) and Precoding Matrix Indicator (PMI).

23. The method of claim 22, wherein:
the configuration information comprises CSI-RS resource information for a channel measurement.

24. The method of claim 21, further comprising:
determining the bitwidth of a Channel state information Reference signal resource Indicator (CRI) based on the number of CSI-RS resources,
wherein the CSI comprises the CRI.

25. The method of claim 21, wherein:
the configuration information comprises spatial information for antenna ports, and
wherein the spatial information is the information for energy saving of the network through adapting spatial domain.

26. A User Equipment (UE) comprising:
a memory storing instructions and
a processor configured to execute the instructions to:
receive configuration information comprising a power offset between a Physical Downlink Shared Channel (PDSCH) and a Channel State Information Reference Signal (CSI-RS),
calculate information for Channel State Information (CSI) based on the configuration information, and
transmit the CSI,
wherein the power offset is information for energy saving of a network through adapting power domain.

27. The UE of claim 26, wherein:
the calculation comprises a calculation of Channel Quality Indicator (CQI) based on the power offset, and
wherein the CQI is related to Rank Indicator (RI) and Precoding Matrix Indicator (PMI).

28. The UE of claim 27, wherein:
the configuration information comprises CSI-RS resource information for a channel measurement.

29. The UE of claim 26, further comprising:
the processor configured to execute the instructions to:
determine the bitwidth of a Channel state information Reference signal resource Indicator (CRI) based on the number of CSI-RS resources,
wherein the CSI comprises the CRI.

30. The UE of claim 26, wherein:
the configuration information comprises spatial information for antenna ports, and
wherein the spatial information is the information for energy saving of the network through adapting spatial domain.
